(19) United States
(12) Patent Application Publication
(10) Pub. No.: US 2024/0176649 A1
(43) Pub. Date: May 30, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: KENTO TAKURA, TOKYO (JP); KUMIKO SO, TOKYO (JP)

(21) Appl. No.: 18/551,179

(22) PCT Filed: Feb. 17, 2022
(86) PCT No.: PCT/JP2022/006434

§ 371 Date: Sep. 18, 2023

(30) Foreign Application Priority Data
Mar. 29, 2021 (JP) 2021-056047

(51) Int. Cl. G06F 9/48; G06F 3/0482

(52) U.S. Cl. CPC G06F 9/48; G06F 3/0482; G06F 2209/482

(57) ABSTRACT

An information processing device includes a control unit configured to launch a second application while a first application is running, the second application being launched through an extension application that provides an extended function to the first application, and display a screen of the second application superimposed on a screen of the first application.

### TECHNICAL FIELD

The present technique relates to an information processing device, an information processing method, and a program.

### BACKGROUND ART

A variety of highly entertaining applications have been developed in recent years. Techniques are also being proposed which create various types of added value by connecting to such applications to add extended functions. For example, PTL 1 discloses a technique for taking an image of a user playing a game application and compositing the image on a game screen for distribution.

### CITATION LIST

### Patent Literature

[PTL 1]
WO 2020/170453

### SUMMARY

### Technical Problem

When adding an extended function to an application, it is important to ensure a pleasant user experience.

Accordingly, the present disclosure proposes a technique that makes it possible to provide a more pleasant user experience.

### Solution to Problem

An information processing device according to the present technique includes a control unit configured to launch a second application while a first application is running, the second application being launched through an extension application that provides an extended function to the first application, and display a screen of the second application superimposed on a screen of the first application.

Additionally, an information processing method according to the present technique includes launching a second application while a first application is running, the second application being launched through an extension application that provides an extended function to the first application, and displaying a screen of the second application superimposed on a screen of the first application.

Additionally, a program according to the present technique causes an information processing device to execute processing of launching a second application while a first application is running, the second application being launched through an extended function that provides an extension application to the first application, and displaying a screen of the second application superimposed on a screen of the first application.

### BRIEF DESCRIPTION OF DRAWINGS

FIG. 1 is a block diagram illustrating an example of the functional configuration of an information processing device according to an embodiment.

FIG. 2 is a diagram illustrating an example of an operation involved in displaying a menu of an extension application.

FIG. 3 is a diagram illustrating an example of an operation position for displaying an extended function menu.

FIG. 4 is a diagram illustrating an example of an operation involved in displaying a menu of an extension application and an OS.

FIG. 5 is a diagram illustrating an example of an extended function menu.

FIG. 6 is a diagram illustrating an example of a multitasking menu.

FIG. 7 is a diagram illustrating an example of an operation involved in switching a second application.

FIG. 8 is a diagram illustrating an example of another operation involved in switching the second application.

FIG. 9 is a diagram illustrating an example of a multitasking operation area.

FIG. 10 is a diagram illustrating another example of an operation involved in switching the second application.

FIG. 11 is a diagram illustrating another example of an operation involved in switching the second application.

FIG. 12 is a diagram illustrating another example of an operation involved in switching the second application.

FIG. 13 is a diagram illustrating an example of operations involved in launching multiple second applications.

FIG. 14 is a diagram illustrating an example of operations involved in launching multiple second applications.

FIG. 15 is a diagram illustrating an example of an operation pertaining to priority of the second applications.

FIG. 16 is a diagram illustrating an example of other operations involved in launching multiple second applications.

FIG. 17 is a diagram illustrating an example of other operations involved in launching multiple second applications.

FIG. 18 is a diagram illustrating an example of a display pertaining to the priority of the second applications.

FIG. 19 is a diagram illustrating another example of a display pertaining to the priority of the second applications.

FIG. 20 is a diagram illustrating another example of a display pertaining to the priority of the second applications.

FIG. 21 is a diagram illustrating an example of other operations involved in launching multiple second applications.

FIG. 22 is a diagram illustrating an example of other operations involved in launching multiple second applications.

FIG. 23 is a block diagram illustrating the hardware configuration of the information processing device.

FIG. 24 is a diagram illustrating an example of the display of a second application screen in a variation.

FIG. 25 is a diagram illustrating an example of the display of a second application screen in a variation.

### DESCRIPTION OF EMBODIMENTS

An embodiment will be described hereinafter according to the following order.
<1. Functional Configuration>
<2. Extended Function>
<3. Example of Hardware Configuration>
<4. Conclusion and Variation>

Note that in the present specification and the drawings, substantially identical parts are given identical reference signs, and redundant descriptions are omitted. In the following descriptions and the drawings, “application” may be shortened to “app”.

### 1. FUNCTIONAL CONFIGURATION

First, an example of the functional configuration of an information processing device 10 according to the present embodiment will be described.

The information processing device 10 may be a mobile terminal such as a smartphone or tablet personal computer (PC) capable of running various applications, or may be a stationary terminal installed at a user's home or office.

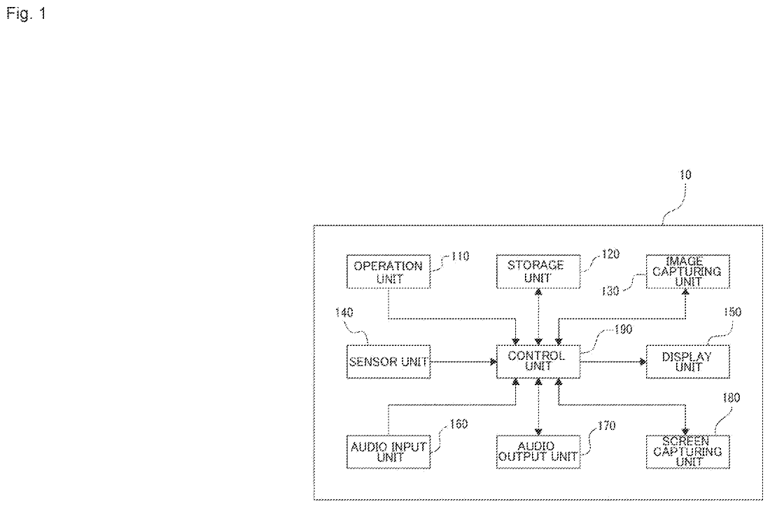

FIG. 1 is a block diagram illustrating an example of the functional configuration of the information processing device 10 according to the present embodiment. As illustrated in FIG. 1, the information processing device 10 includes an operation unit 110, a storage unit 120, an image capturing unit 130, a sensor unit 140, a display unit 150, an audio input unit 160, an audio output unit 170, a screen capturing unit 180, and a control unit 190.

### (Operation Unit 110)

The operation unit 110 detects various operations by the user, such as device operations made for an app. The device operations include, for example, touch operations, pressing operations, the insertion of an earphone jack into the information processing device 10, and the like. Here, “touch operation” refers to various contact actions made on the display unit 150, such as tapping, double-tapping, swiping, pinching, and the like, for example. Touch operations also include, for example, moving an object such as a finger close to the display unit 150. “Pressing operation” refers to an operation in which the operation unit 110 is pressed down. To that end, the operation unit 110 includes a touch panel, buttons, a keyboard, a mouse, a proximity sensor, and the like, for example. The operation unit 110 inputs information pertaining to the detected user operation to the control unit 190.

### (Storage Unit 120)

The storage unit 120 is a storage area for temporarily or permanently storing various programs and data. For example, the storage unit 120 may store programs and data for the information processing device 10 to execute various functions. As a specific example, the storage unit 120 may store programs for executing various applications, management data for managing various settings, and the like. Of course, this is merely an example, and the types of data stored in the storage unit 120 are not particularly limited.

### (Image Capturing Unit 130)

The image capturing unit 130 captures images of, for example, the face of the user operating the information processing device 10, based on control by the control unit 190. To that end, the image capturing unit 130 includes an image sensor. A smartphone, which is an example of the information processing device 10, includes a front camera, which is located on the display unit 150 side to capture images of the user's face and the like, and a main camera, which is located on the back side of the display unit 150 to capture images of scenery and the like. In the present embodiment, the control unit 190 controls the capturing of images by the front camera, as an example.

### (Sensor Unit 140)

The sensor unit 140 has a function of collecting sensor information pertaining to user behavior using various sensors. The sensor unit 140 includes, for example, an accelerometer, a gyrosensor, a terrestrial magnetism sensor, a vibration sensor, a Global Navigation Satellite System (GNSS) signal receiver, and the like. The sensor unit 140 uses the gyrosensor to detect that the user is holding the information processing device 10 in landscape orientation, and inputs the detected information to the control unit 190, for example.

### (Display Unit 150)

The display unit 150 displays various types of visual information based on control by the control unit 190. The display unit 150 may, for example, display images pertaining to applications. To that end, the display unit 150 includes various types of display devices, such as a liquid crystal display (LCD) device, an organic light emitting diode (OLED) display device, or the like. The display unit 150 can also superimpose a user interface (UI) of another application on a layer higher than the image of the application being displayed.

### (Audio Input Unit 160)

The audio input unit 160 collects voice and the like from the user based on control by the control unit 190. To that end, the audio input unit 160 includes a microphone or the like.

### (Audio Output Unit 170)

The audio output unit 170 outputs various types of audio. The audio output unit 170 outputs audio or sound according to the status of the application, based on control by the control unit 190, for example. To that end, the audio output unit 170 includes a speaker, an amplifier, and the like.

### (Screen Capturing Unit 180)

The screen capturing unit 180 takes screenshots (SS), moving images, and the like of the screen displayed in the display unit 150 and stores those items in the storage unit 120 based on control by the control unit 190.

### (Control Unit 190)

The control unit 190 controls each constituent element of the information processing device 10. The control unit 190 also controls function extensions to applications. Note that function extensions to an application are made by another application. To distinguish between the application for which functions are to be extended and the other application that extends the functions, the applications with be called a “first application” and an “extension application”, respectively.

When extending functions, the control unit 190 launches the extension application in addition to the first application and controls both applications simultaneously. As an example of function extension, the control unit 190 causes an application different from the first application and the extension application to be launched (executed) through the extension application. The application launched through the extension application will be called a “second application”.

Details of the functions of the control unit 190 will be described later.

Although an example of the functional configuration of the information processing device 10 has been described thus far, the functional configuration described with reference to FIG. 1 is merely an example, and the functional configuration of the information processing device 10 is not limited to this example.

For example, the information processing device 10 does not necessarily have to include all of the constituent elements illustrated in FIG. 1, and each constituent element, such as the audio input unit 160, can be provided in another device different from the information processing device 10. In other words, the functional configuration of the information processing device 10 can be modified in a flexible manner according to the specifications and operations.

The functions of each constituent element may be performed by an arithmetic device such as a central processing unit (CPU) reading out a control program describing a processing sequence for realizing those functions from a recording medium such as a read-only memory (ROM) or a random access memory (RAM) that stores the control program, and interpreting and executing the program. Accordingly, the configuration to be used can be changed appropriately in accordance with the technical level when carrying out the present embodiment. An example of the hardware configuration of the information processing device 10 will be described later.

### 2. EXTENDED FUNCTION

### [2.1 Overview of Extension Application]

The functions of the information processing device 10 will be described next.

One feature of the control unit 190 of the information processing device 10 is to control the execution of the extension application that provides an extended function to various types of the first application.

The first application is, for example, a game application. However, the first application is not limited to a game application, and includes various types of applications installed in the information processing device 10 and used by the user, such as a drawing application, an editing application, a music application for listening to music and viewing movies, an application for recording audio and video, and the like.

An extension application can easily provide extended functions to various types of the first application without editing the source code thereof. When providing extended functions, the extension application can also operate in such a way that it does not interfere with user operations in the first application or the operating system (OS) and the behavior of the first application.

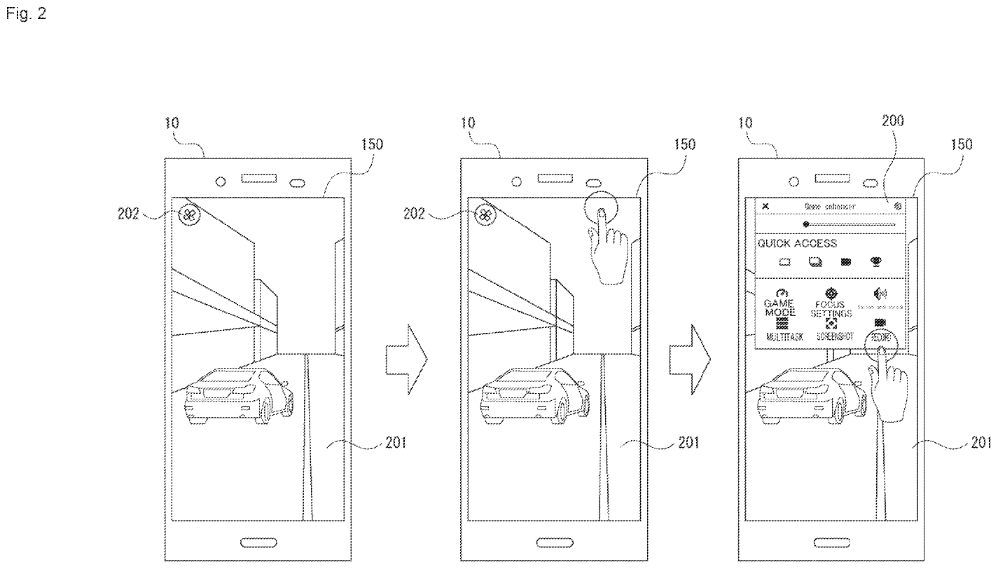

FIG. 2 is a diagram illustrating an example of an operation involved in displaying a menu of the extension application.

In FIG. 2, the user has put the information processing device 10 in portrait orientation, which is detected by the sensor unit 140, and the screen in the display unit 150 is displayed in portrait mode by the control unit 190.

The left side of FIG. 2 illustrates a state in which the control unit 190 has already launched the first application (in this case, a game application) and the screen of the first application is displayed in full screen mode in the display unit 150. In the following, the screen of the first application may be referred to as a “first application screen 201”.

A GE icon 202 is displayed in the display unit 150 in the left side of FIG. 2. The GE icon 202 is an icon for displaying an extended function menu 200 of the extension application.

The extension application may be launched by the control unit 190 upon detecting the first application being launched, or may be launched upon detecting a given operation while the first application is running. The given operation is, for example, a user operation detected by the operation unit 110 or the sensor unit 140, or voice operations recognized by the audio input unit 160. For example, the extension application may be launched when the GE icon 202 displayed in the display unit 150 is tapped by the user.

The extension application may be automatically launched when the OS of the information processing device 10 is launched.

Although the extension application may also be running while the first application is running, the GE icon 202 may not be displayed when the extension application is not being used by the user.

A logo or the like may be displayed when the extension application is launched, and for example, the logo may be controlled to automatically be displayed smaller or disappear after a set period of time by the control unit 190. This enables the extension application to operate in a manner that does not interfere with user operations in the first application or the OS and the behavior of the first application when the extension application is not in use by the user.

The center of FIG. 2 illustrates a user about to perform a touch operation on the display unit 150 in order to use the extension application.

The right side of FIG. 2 illustrates the extended function menu 200 of the extension application superimposed on the first application screen 201 as a result of the user swiping from the edge of the screen in the display unit 150.

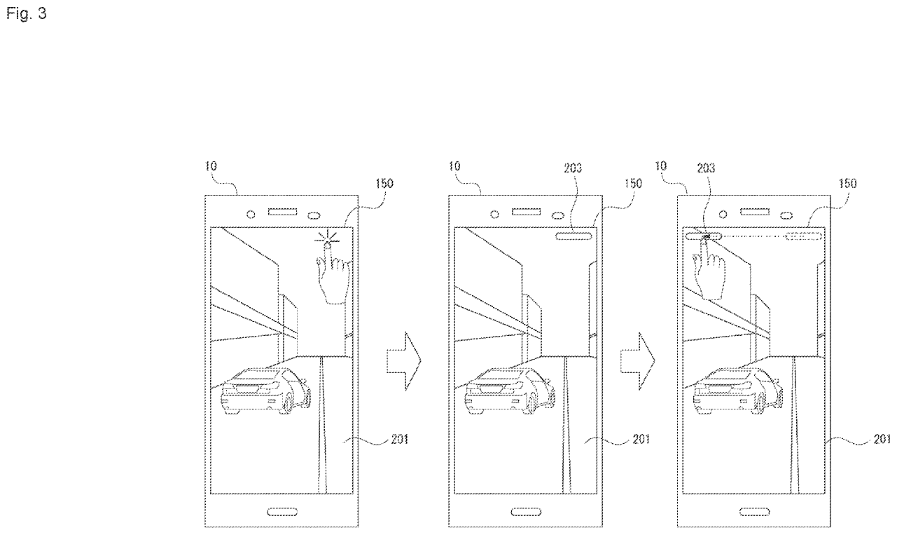

The extended function menu 200 is a pull-down menu that expands from the edge of the screen in response to a swiping motion, for example. Although details will be given later, the extended function menu 200 is displayed when a menu bar 203 (the center of FIG. 3) is swiped. As such, strictly speaking, the operation unit 110 detects a touch operation on the display unit 150, information on the detected operation and position (screen coordinates) are sent to the control unit 190, and the control unit 190 determines whether to display the extended function menu 200. When a condition for displaying the extended function menu 200 (a predetermined operation at a predetermined position) is met, the control unit 190 causes the display unit 150 to display the extended function menu 200.

Note that the touch operation for displaying the extended function menu 200 is not limited to swiping, and may also be a tap, a double-tap, a pinch, or the like. The extended function menu 200 may also be displayed by tapping the GE icon 202. The display position of the extended function menu 200 is not limited to the upper part of the display unit 150 as illustrated on the right side of FIG. 2, and may be at various positions in the display unit 150.

Although not illustrated in the drawings, when the display unit 150 is set in what is known as landscape mode, the extended function menu 200 of the extension application is superimposed on the first application by the user swiping in the display unit 150 in the same manner as with the portrait mode illustrated in FIG. 2.

FIG. 3 is a diagram illustrating an example of an operation position for displaying the extended function menu 200. Fixing the operation position for displaying the extended function menu 200 of the extension application may significantly interfere with user operations in the first application and the OS, as well as the behavior of the first application.

For example, there are situations where the operation position is set to an operation button, an icon, or the like of the first application, a display part of the first application that the user wishes to always be able to see, or the like. Therefore, the operation position for displaying the extended function menu 200 is controlled by the control unit 190 so as to be freely changeable by the user.

The left side of FIG. 3 illustrates a state in which the user is tapping a predetermined position on the display unit 150 to change the operation position for displaying the extended function menu 200. The predetermined position here is, for example, a predetermined area in the vicinity of the position where the swipe is started to expand the extended function menu 200 (the center of FIG. 2).

The center of FIG. 3 illustrates the extension application menu bar 203 displayed by a tap on the display unit 150 (the left side of FIG. 3). Note that the touch operation for displaying the menu bar 203 is not limited to tapping. Because the menu bar 203 is superimposed on the first application screen 201, it is desirable that the menu bar 203 be of a shape, color, size, and transparency that does not interfere with the display of the first application screen 201 to the greatest extent possible. However, the menu bar 203 is not limited to such a shape and the like.

The menu bar 203 is also controlled by the control unit 190 to be hidden when an area of the display unit 150 aside from the menu bar 203 is tapped or the menu bar 203 has not been operated for a set period of time. In this manner, the menu bar 203 is also controlled by the control unit 190 to be hidden when not used by the user. This enables the extension application to operate in a manner that interferes even less with user operations in the first application or the OS and the behavior of the first application.

The right side of FIG. 3 illustrates a state in which the user has moved the menu bar 203, which had been displayed in an upper-right part of the display unit 150, to an upper-left part of the display unit 150 through a drag-and-drop operation.

Through this, the display position of the menu bar 203 is changed from the upper-right part of the display unit 150 (the center of FIG. 3) to the upper-left part (the left side of FIG. 3). Note that the display position of the menu bar 203 is not limited to the upper-right part, the upper-left part, or the like of the display unit 150.

Additionally, the post-change display position of the menu bar 203, on the right side of FIG. 3, is stored in the storage unit 120 by the control unit 190, and the menu bar 203 is displayed in the stored display position thereafter when using the extension application.

Furthermore, the display position of the menu bar 203 may be stored in the storage unit 120 for each first application, in association with that first application. This eliminates the need to change the display position of the menu bar 203 each time according to the first application when a variety of first applications are used.

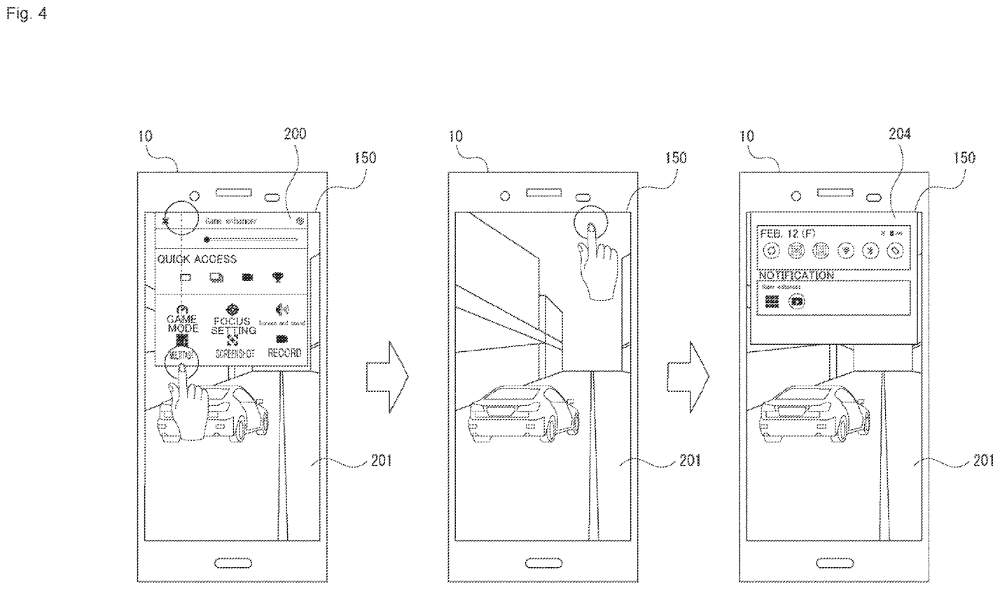

FIG. 4 is a diagram illustrating an example of an operation involved in displaying a menu of the extension application and the OS.

As illustrated on the left side of FIG. 4, swiping from the edge of the screen can also be used to display an OS menu 204. In other words, there are situations where the extended function menu 200 and the OS menu 204 are displayed by the same operation.

In such a case, the control unit 190 may perform control to prioritize the display of the extended function menu 200 (the left side of FIG. 4) in response to a swipe made at a predetermined position, and display the OS menu 204 (the center and the right side of FIG. 4) in response to swipes made at other positions.

To be more specific, for example, the OS menu 204 is originally displayed by swiping from any position at the edge of the screen in the upper part of the display unit 150. However, the extended function menu 200 is set to be displayed in response to a swipe from an upper-left part of the display unit 150, i.e., a swipe on the menu bar 203, and thus the control unit 190 performs control for prioritizing the display of the extended function menu 200 (the left side of FIG. 4).

On the other hand, the control unit 190 performs control for displaying the OS menu 204 (the right side of FIG. 4) when a swipe is made from an upper-right part of the display unit 150, i.e., from a position aside from the menu bar 203 (the center of FIG. 4).

Of course, if the display position of the extended function menu 200 is set to the upper-right part of the display unit 150, the control unit 190 may perform control for displaying the extended function menu 200 in response to a swipe from the upper-right part of the display unit 150 and displaying the OS menu 204 in response to a swipe from the upper-left part.

Additionally, if the display position of the extended function menu 200 is set to a position aside from the upper part of the display unit 150, the control unit 190 performs control for displaying the OS menu 204 regardless of which position a swipe is made from at the edge of the screen on the upper part of the display unit 150.

This makes it possible for the extension application to operate in a manner that does not interfere with the user operations made in the OS.

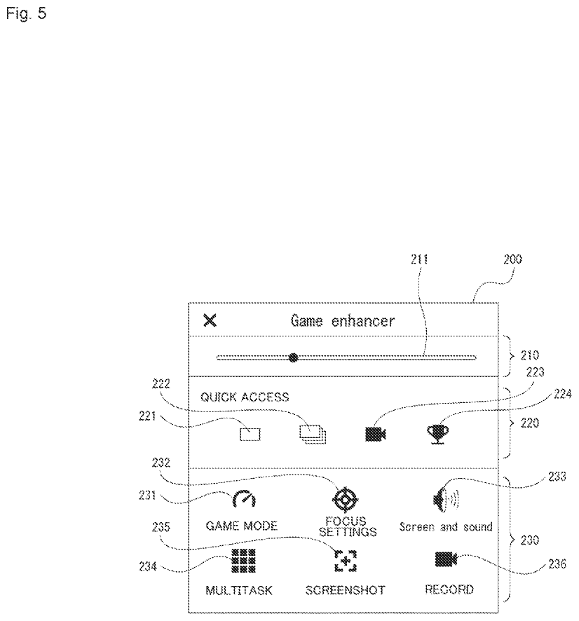

FIG. 5 is a diagram illustrating an example of the extended function menu 200. As illustrated in FIG. 5, for example, a brightness adjustment bar display area 210, a quick access icon display area 220, and a menu icon display area 230 are provided in the extended function menu 200 of the extension application.

The brightness adjustment bar display area 210 is an area in which a brightness adjustment bar 211 is displayed. When the brightness adjustment bar 211 is dragged by the user, the control unit 190 changes the brightness of the display unit 150 to a brightness corresponding to the position to which the brightness adjustment bar 211 was dragged.

The quick access icon display area 220 is an area that displays icons for immediately using various functions from the extended function menu 200. In the example illustrated in FIG. 5, an SS icon 221, a continuous SS icon 222, a record icon 223, and a limit all icon 224 are provided in the quick access icon display area 220.

When the SS icon 221 is tapped by the user, the control unit 190 captures a single screenshot (image) of the screen displayed in the display unit 150 through the screen capturing unit 180, and stores the captured image in the storage unit 120.

When the continuous SS icon 222 is tapped by the user, the control unit 190 captures a plurality of screenshots of the screen displayed in the display unit 150, continuously for a set period of time (what is known as “burst mode” shooting), through the screen capturing unit 180. The control unit 190 then generates a data file of the plurality of screenshots captured in the set period of time, in a format such as the GIF format, and stores the data file in the storage unit 120. This makes it possible to achieve a smaller file size than that of a moving image file while maintaining a high framerate (frames per second; fps), which makes it easier to capture a decisive moment during shooting, even with a smartphone or the like.

When the record icon 223 is tapped by the user, the control unit 190 performs control to capturing moving image of the screen displayed in the display unit 150 through the screen capturing unit 180.

Note that the extended function menu 200 is controlled to be hidden by the control unit 190 when the SS icon 221, the continuous SS icon 222, or the record icon 223 is tapped. This makes it possible to ensure the extended function menu 200 does not appear in the captured image.

When the limit all icon 224 is tapped by the user, the control unit 190 performs processing for limiting a plurality of functions all at once.

A game mode icon 231, a focus icon 232, a screen and sound icon 233, a multitask icon 234, a screenshot icon 235, and a record icon 236 are displayed in the menu icon display area 230.

The game mode icon 231 is an icon for displaying a UI for setting a game mode.

The focus icon 232 is an icon for displaying a UI for selecting the type of menu display, e.g., floating or the like.

As will be described in detail later, the multitask icon 234 is an icon for displaying a UI for causing another application, another function, or the like to be executed at the same time as the first application.

The screenshot icon 235 is an icon for displaying a UI for screenshot operations. The record icon 236 is an icon for displaying a UI for video recording (or video and audio recording) operations.

When the game mode icon 231, the focus icon 232, the screen and sound icon 233, the multitask icon 234, the screenshot icon 235, or the record icon 236 is tapped, the control unit 190 displays the UI corresponding to the tapped icon in the display unit 150.

Note that the display content of the extended function menu 200 illustrated in FIG. 5 is merely an example, and is not limited thereto. Icons, areas, and the like for using various functions providing extended functions to the first application may be added or removed, the arrangement thereof can be changed, and the like. Various shapes, colors, sizes, transparencies, and the like are also conceivable for the extended function menu 200.

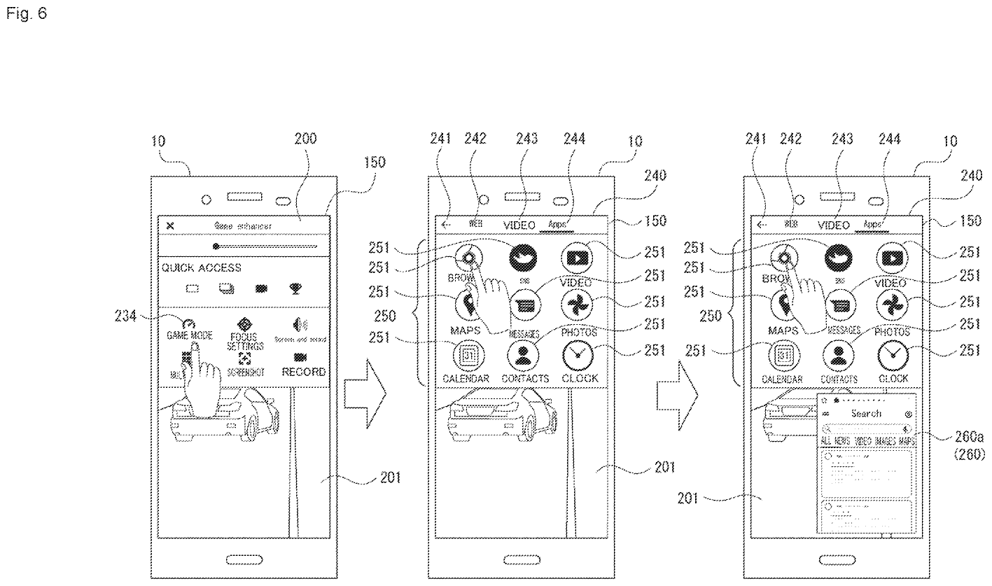

FIG. 6 is a diagram illustrating an example of a multitask UI 240.

When the multitask icon 234 of the extended function menu 200 is tapped as illustrated on the left side of FIG. 6, the control unit 190 displays the multitask UI 240 instead of the extended function menu 200, as illustrated in the center of FIG. 6.

The multitask UI 240 is provided with a return icon 241, a web selection icon 242, a video selection icon 243, and an app selection icon 244, as well as a task display area 250 provided below those icons.

When the return icon 241 is tapped by the user, the control unit 190 hides the multitask UI 240 and displays the extended function menu 200 again.

When the web selection icon 242 is tapped by the user, the control unit 190 displays a UI for displaying a website in the task display area 250.

When the video selection icon 243 is tapped by the user, the control unit 190 displays a UI for playing back a video from a predetermined operation site in the task display area 250.

When the app selection icon 244 is tapped by the user, the control unit 190 displays a plurality of app icons 251 in the task display area 250, as illustrated in the center of FIG. 6.

The app icons 251 are icons for launching second applications, with one icon provided for a corresponding second application.

Here, the second applications are applications launched through the extension application, and include a variety of applications, such as, for example, an application for displaying websites, an application for a social networking service (SNS), an application for playing back video, and the like. The second applications are applications installed in the information processing device 10, for example.

Then, the app icons 251 corresponding to all applications installed in the information processing device 10 are displayed in the task display area 250. Note that the second applications may be stored in association with each first application, and the app icons 251 corresponding to the second applications associated with the first application that is running may be displayed in the task display area 250.

Additionally, the app icons 251 may be displayed in the task display area 250 in order of the names (alphabetically) of the corresponding second applications. The control unit 190 may also count the number of times a second application has been launched for each first application and arrange the app icons 251 in order from the application which has been launched the greatest number of times.

In this manner, the order of the app icons 251 displayed in the task display area 250 may be any order.

Then, when one of the app icons 251 displayed in the task display area 250 is tapped, the control unit 190 launches the second application corresponding to the tapped app icon 251. The control unit 190 then displays a screen of the launched second application (referred to as a “second application screen” hereinafter) superimposed over the first application screen 201.

For example, in the example illustrated in the center of FIG. 6, the app icon 251 corresponding to the second application for displaying a website is tapped, and as a result, a screen of the second application for displaying a website is displayed in the display unit 150, as illustrated in the right side of FIG. 6.

Note that in the following, the second application screen will be referred to as a “second application screen 260” when the descriptions do not distinguish between individual second applications. Additionally, in the following, the second application for displaying a website will be referred to as a “browser app”, the second application for an SNS will be referred to as an “SNS app”, and the second application for playing back video will be referred to as a “video app”.

Furthermore, the second application screen corresponding to the browser app will be referred to as a “browser app screen 260a”, the second application screen corresponding to the SNS app will be referred to as an “SNS app screen 260b”, and the second application screen corresponding to the video app will be referred to as a “video app screen 260c”.

Additionally, the size and position of the second application screen 260 displayed in the display unit 150 may be pre-set for each second application, and stored in association with the first application. Furthermore, the size and position of the second application screen 260 may be stored in the storage unit 120 for each second application when that second application is terminated, and the second application screen 260 may then be displayed at the stored size and position when the second application is launched again.

Additionally, when the app icon 251 corresponding to the browser app is tapped and the browser app screen 260a is displayed in the display unit 150, the control unit 190 performs control to continue to display the multitask UI 240.

[2.2 Switching of Second Application]

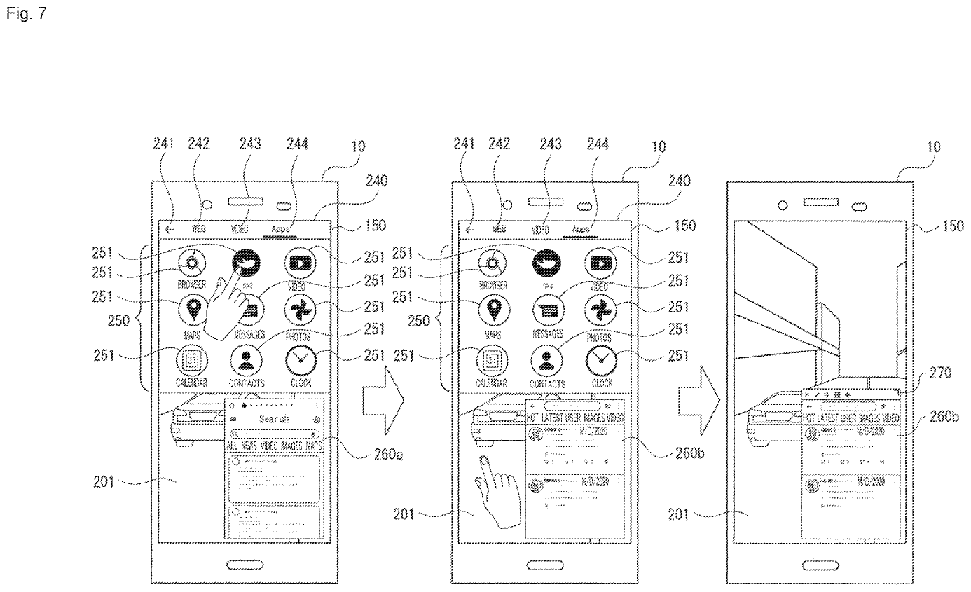

FIG. 7 is a diagram illustrating an example of an operation involved in switching the second application.

In the information processing device 10, the second application to be launched can be switched when in a single mode, in which only one second application is to be launched.

As described above, in the information processing device 10, when one of the app icons 251 displayed in the task display area 250 is tapped, the second application corresponding to the tapped app icon 251 is launched, and the second application screen 260 is displayed in the display unit 150.

However, many app icons 251 are displayed in the task display area 250, and the user may therefore tap on the wrong app icon 251. In such a case, if, for example, the extended function menu 200 is displayed again, the task display area 250 is displayed by tapping on the multitask icon 234, and the app icon 251 corresponding to the desired second application is tapped by the user, this forces the user to perform touch operations multiple times.

Accordingly, as described above, the control unit 190 keeps the extended function menu 200 displayed even when the app icon 251 is tapped and the second application screen 260 is displayed.

Assume that, for example, the browser app is running and the browser app screen 260a is displayed in the display unit 150 along with the extended function menu 200, as illustrated on the left side of FIG. 7. If the app icon 251 corresponding to the SNS app is displayed in this state, the control unit 190 terminates the browser app and launches the SNS app. Additionally, as illustrated in the center of FIG. 7, the control unit 190 hides the browser app screen 260a and displays the SNS app screen 260b superimposed on the first application screen 201.

The control unit 190 also performs control to keep the extended function menu 200 displayed when the SNS app screen 260b is displayed.

Then, when the first application screen 201 or the second application screen 260 is tapped by the user as illustrated in the center of FIG. 7, the control unit 190 hides the multitask UI 240 and puts the application corresponding to the tapped screen into focus, as illustrated on the right side of FIG. 7. Here, “focus” refers to a state in which an application is set to have a higher priority than other applications, such that when a user makes a touch operation, processing corresponding to that touch operation is executed.

For example, when the area where the first application screen 201 is displayed is tapped, the control unit 190 hides the multitask UI 240 and focuses on the first application. Then, when a touch operation is made on the display unit 150, the control unit 190 executes processing corresponding to the touch operation for the first application.

Note that if the user taps the second application screen 260 while the first application is focused on, for example, the control unit 190 focuses on the second application instead.

In this manner, the control unit 190 launches the second application through the extension application while the first application is running, and displays the second application screen 260 superimposed on the first application screen 201.

The control unit 190 can therefore execute the second application at the same time as the first application.

For example, when the user wishes to look up a strategy or the like for the first application on a website, the user can, by launching the browser app, look up the strategy or the like on a website while running the first application.

Additionally, if the user wishes to watch a video in their free time while running the first application, the user can, by launching the video app, watch a video while running the first application.

This enables the information processing device 10 to improve the user experience. In particular, executing an application installed in the information processing device 10 as a second application makes it possible to provide better usability to the user then when performing searches, playing back video, or the like through the extension application.

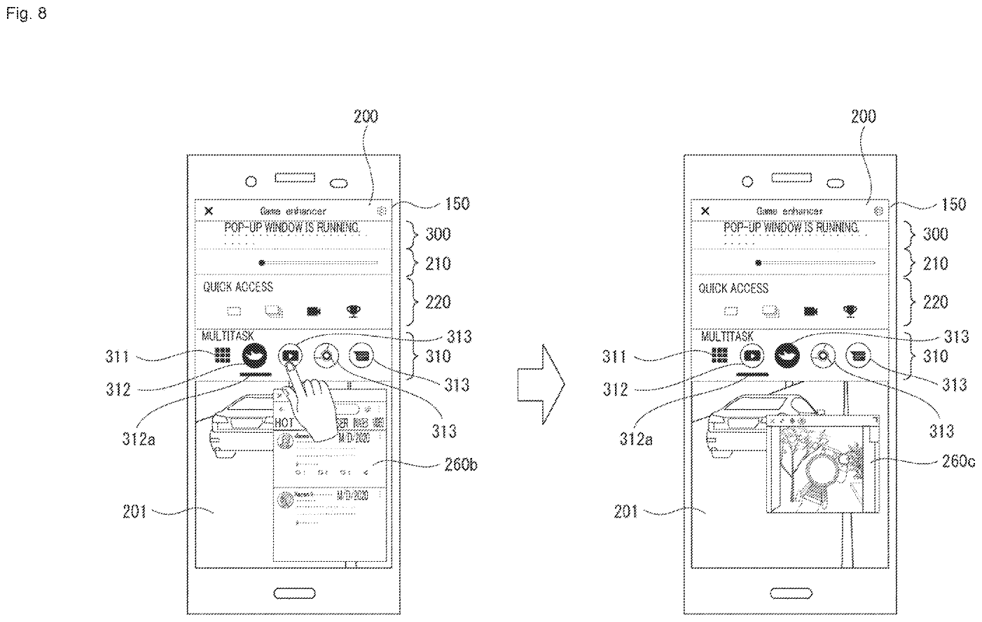

FIG. 8 is a diagram illustrating an example of another operation involved in switching the second application.

If a user operation for displaying the extended function menu 200 is made while the second application screen 260 (the SNS app screen 260b, here) is displayed superimposed on the first application screen 201, the control unit 190 displays the extended function menu 200 in the display unit 150, as illustrated on the left side of FIG. 8.

A multitask running display area 300 and a multitask selection area 310 are provided in the extended function menu 200 displayed here, in addition to the brightness adjustment bar display area 210 and the quick access icon display area 220. In other words, the extended function menu 200 when the second application is running differs from when the second application is not running in that the menu icon display area 230 is not provided, and instead, the multitask running display area 300 and the multitask selection area 310 are provided.

Text or the like indicating that the second application is running and that tapping the multitask running display area 300 will terminate the second application is displayed in the multitask running display area 300.

When the multitask running display area 300 is tapped, the control unit 190 terminates the second application and hides the second application screen 260.

The control unit 190 also displays the extended function menu 200 as illustrated on the left side of FIG. 6.

A multitask icon 311, a running app icon 312, and candidate app icons 313 are arranged and displayed in the multitask selection area 310. The multitask icon 311 will be described in detail later.

The running app icon 312 is an icon corresponding to the second application currently running. The running app icon 312 is displayed further on the left of the screen than the candidate app icons 313. An icon bar 312a, which indicates that the corresponding second application is running, is displayed below the running app icon 312.

The candidate app icons 313 are icons corresponding to second applications which are not running, and three of these icons are displayed, for example. The candidate app icons 313 may be displayed, for example, in alphabetical order for three applications installed in the information processing device 10. The control unit 190 may also count the number of times a second application has been launched for each first application and arrange the candidate app icons 313 in order from the application which has been launched the greatest number of times.

For example, when the candidate app icon 313 corresponding to the video app, displayed in the multitask selection area 310, is tapped as illustrated on the left side of FIG. 8, the control unit 190 terminates the SNS app that is running and launches the video app corresponding to the candidate app icon 313 that was tapped. In other words, the control unit 190 switches the second application and launches the new second application.

Additionally, as illustrated on the right side of FIG. 8, the control unit 190 hides the SNS app screen 260b and displays the video app screen 260c superimposed on the first application screen 201. Furthermore, the control unit 190 displays the icon corresponding to the video app as the running app icon 312, and displays the icon corresponding to the terminated SNS app as a candidate app icon 313.

Note that if the extended function menu 200 continues to be displayed when the video app screen 260c is displayed, and the first application screen 201 or the second application screen 260 is tapped by the user, the control unit 190 hides the extended function menu 200 and focuses on the application corresponding to the tapped application screen.

Another method for switching the second application will be described next. Here, a multitask operation area 270 displayed along with the second application screen 260 will be described first, and the other method for switching the second application will be described thereafter.

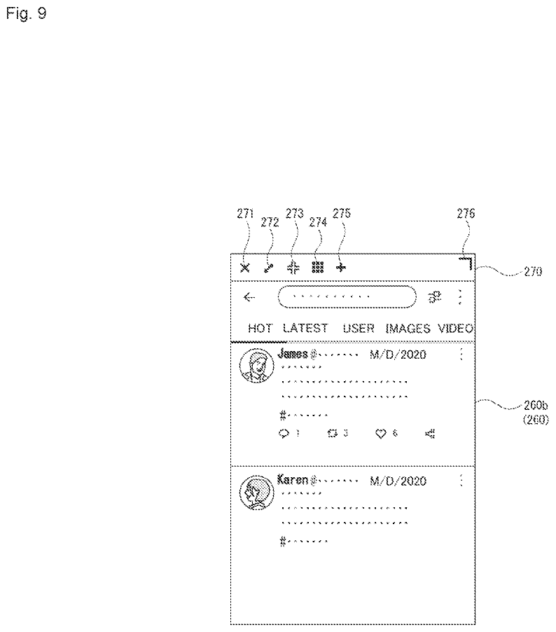

FIG. 9 is a diagram illustrating an example of the multitask operation area 270. As illustrated in FIG. 9, the multitask operation area 270 is displayed above the second application screen 260. Note that the multitask operation area 270 is hidden while the extended function menu 200 or the multitask UI 240 is being displayed in the display unit 150 (see FIG. 7), and is displayed above the second application screen 260 when the extended function menu 200 and the multitask UI 240 are hidden.

A close icon 271, a maximize icon 272, a minimize icon 273, a multitask icon 274, an add app icon 275, and a change size icon 276 are provided in the multitask operation area 270. In other words, it can be said that these icons are displayed in positions corresponding to the second application screen 260.

The close icon 271 is an icon for terminating the corresponding second application. When the close icon 271 is tapped, the control unit 190 terminates the corresponding second application and hides the second application screen 260.

The maximize icon 272 is an icon for maximizing the corresponding second application screen 260. When the maximize icon 272 is tapped, the control unit 190 displays the second application screen 260 at the full size of the screen in the display unit 150. Note that if the maximize icon 272 is tapped again while the second application screen 260 is maximized, the control unit 190 displays the second application screen 260 at the size and position from before the maximization. Accordingly, the control unit 190 stores the size and position of the second application screen 260 when the maximize icon 272 is tapped.

The minimize icon 273 is an icon for minimizing the second application screen 260. When the minimize icon 273 is tapped, the control unit 190 hides the corresponding second application screen 260. Note that when the minimize icon 273 is tapped, the control unit 190 hides the second application screen 260, but does not terminate the second application.

The multitask icon 274 is an icon for switching between second applications that are running. The processing performed when the multitask icon 274 is tapped will be described in detail later.

The add app icon 275 is an icon for adding a second application to be launched.

The processing performed when the add app icon 275 is tapped will be described in detail later.

The change size icon 276 is an icon for changing the size of the second application screen 260. When the change size icon 276 is dragged, the control unit 190 changes the size of the second application screen 260 in accordance with the position to which the icon has been dragged.

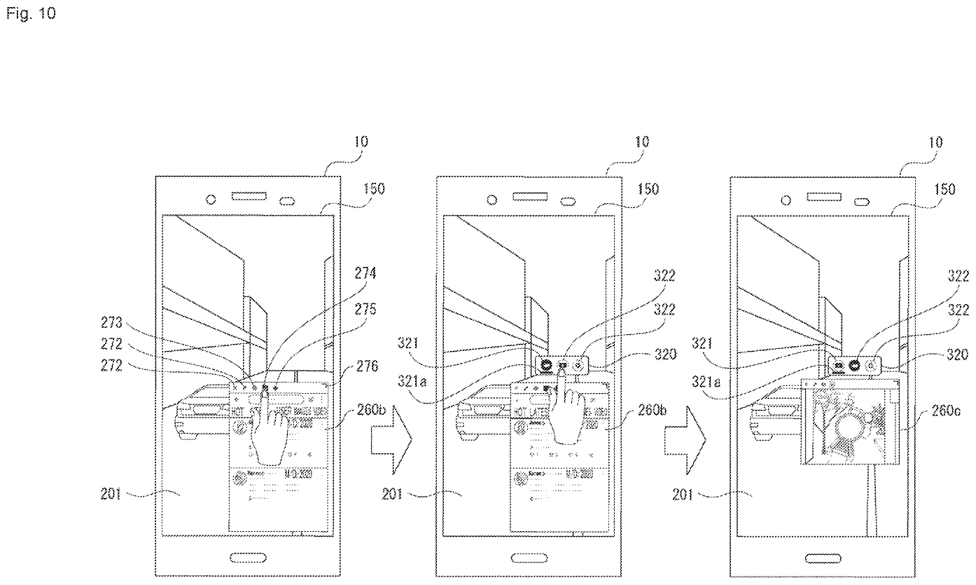

FIG. 10 is a diagram illustrating another example of an operation involved in switching the second application.

When the multitask icon 274 in the multitask operation area 270 displayed above the SNS app screen 260b is tapped as illustrated on the left side of FIG. 10, the control unit 190 displays an app selection pop-up 320 above the multitask operation area 270, as illustrated in the center of FIG. 10.

A running app icon 321 and candidate app icons 322 are arranged and displayed in the app selection pop-up 320.

The running app icon 321 is an icon corresponding to the second application currently running. In the example in the center of FIG. 10, the icon corresponding to the SNS app, which is currently running, is displayed as the running app icon 321.

The running app icon 321 is then displayed to the left of the candidate app icons 322 in the app selection pop-up 320. An icon bar 321a, which indicates that the corresponding second application is running, is displayed below the running app icon 321.

The candidate app icons 322 are icons corresponding to second applications which are not running, and two of these icons are displayed, for example. Two of the candidate app icons 322 may be displayed, for example, in alphabetical order for applications installed in the information processing device 10. The control unit 190 may also count the number of times a second application has been launched for each first application and arrange the candidate app icons 322 in order from the application which has been launched the greatest number of times.

For example, when the candidate app icon 322 corresponding to the video app, displayed in the app selection pop-up 320, is tapped as illustrated in the center of FIG. 10, the control unit 190 terminates the SNS app that is running and launches the video app corresponding to the candidate app icon 322 that was tapped.

Additionally, as illustrated on the right side of FIG. 10, the control unit 190 hides the SNS app screen 260b and displays the video app screen 260c superimposed on the first application screen 201. Furthermore, the control unit 190 displays the icon corresponding to the video app as the running app icon 321, and displays the icon corresponding to the terminated SNS app as a candidate app icon 322.

Note that the app selection pop-up 320 remains displayed when the video app screen 260c is displayed. Then, when the first application screen 201 or the second application screen 260 is tapped by the user, the control unit 190 hides the app selection pop-up 320 and focuses on the application corresponding to the tapped application screen.

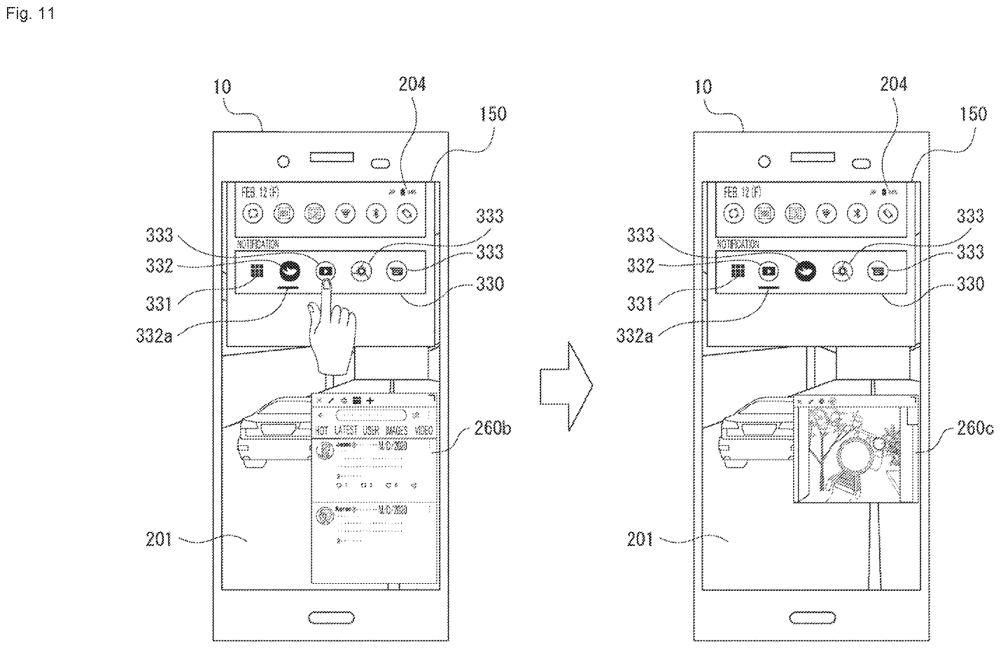

Yet another method for switching the second application will be described next. FIG. 11 is a diagram illustrating another example of an operation involved in switching the second application.

When an operation for displaying the OS menu 204 is made by the user while the second application is running, the control unit 190 displays the OS menu 204 as illustrated on the left side of FIG. 11.

When the OS menu 204 is displayed while the second application is running, an extension app notification box 330 is displayed in the OS menu 204.

The extension app notification box 330 is an area for making a notification pertaining to the extension application, and a multitask icon 331, a running app icon 332, and candidate app icons 333 are arranged and displayed therein. The multitask icon 331 will be described in detail later.

The running app icon 332 is an icon corresponding to the second application currently running. In the example on the left side of FIG. 11, the SNS app is currently running, and an icon corresponding to the SNS app is displayed as the running app icon 332.

The running app icon 332 is displayed to the left of the candidate app icons 333 in the extension app notification box 330. An icon bar 332a, which indicates that the corresponding second application is running, is displayed below the running app icon 332.

The candidate app icons 333 are icons corresponding to second applications which are not running, and three of these icons are displayed, for example. Three of the candidate app icons 333 may be displayed, for example, in alphabetical order for applications installed in the information processing device 10. The control unit 190 may also count the number of times a second application has been launched for each first application and arrange the candidate app icons 333 in order from the application which has been launched the greatest number of times.

For example, when the candidate app icon 333 corresponding to the video app, displayed in the extension app notification box 330, is tapped as illustrated on the left side of FIG. 11, the control unit 190 terminates the SNS app that is running and launches the video app corresponding to the candidate app icon 333 that was tapped.

Additionally, as illustrated on the right side of FIG. 11, the control unit 190 hides the SNS app screen 260b and displays the video app screen 260c superimposed on the first application screen 201. Furthermore, the control unit 190 displays the icon corresponding to the video app as the running app icon 332, and displays the icon corresponding to the terminated SNS app as a candidate app icon 333.

Note that the OS menu 204 remains displayed when the video app screen 260c is displayed. Then, when the first application screen 201 or the second application screen 260 is tapped by the user, the control unit 190 hides the OS menu 204 and focuses on the application corresponding to the tapped application screen.

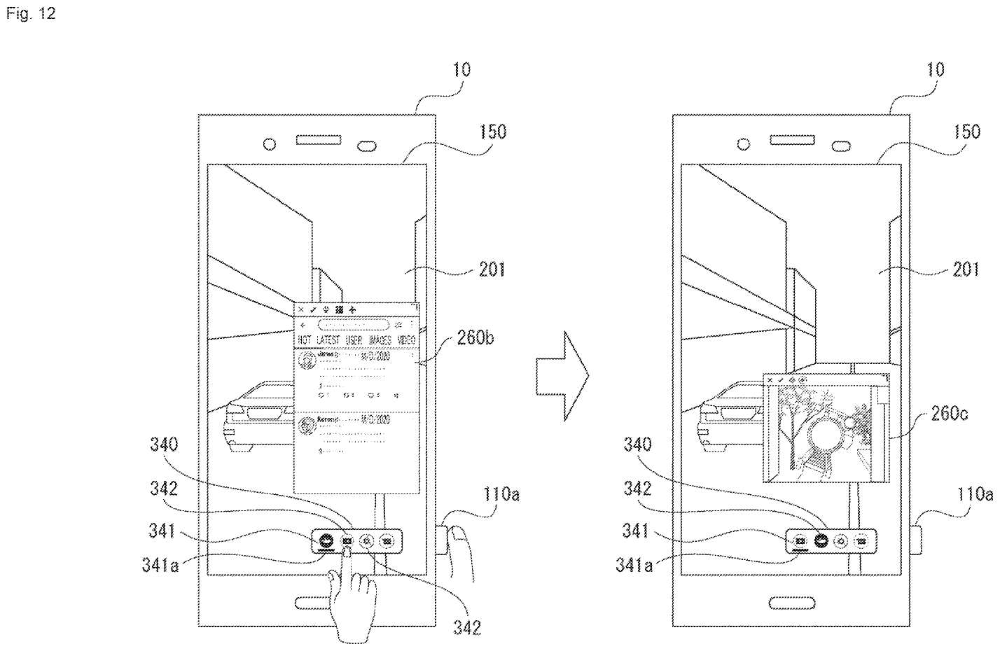

Yet another method for switching the second application will be described next. FIG. 12 is a diagram illustrating another example of an operation involved in switching the second application.

As illustrated on the left side of FIG. 12, when an operation for pressing an operation button 110a, which serves as a predetermined operation unit 110, is performed by the user while the second application is running, the control unit 190 displays an app selection pop-up 340 in (a corresponding position in) the vicinity of the operation unit 110.

A running app icon 341 and candidate app icons 342 are arranged and displayed in the app selection pop-up 340.

The running app icon 341 is an icon corresponding to the second application currently running (the SNS app, here). The running app icon 341 is then displayed to the left of the candidate app icons 342 in the app selection pop-up 340. An icon bar 341a, which indicates that the corresponding second application is running, is displayed below the running app icon 341.

The candidate app icons 342 are icons corresponding to second applications which are not running, and two of these icons are displayed, for example. Two of the candidate app icons 342 may be displayed, for example, in alphabetical order for applications installed in the information processing device 10. The control unit 190 may also count the number of times a second application has been launched for each first application and arrange the candidate app icons 342 in order from the application which has been launched the greatest number of times.

For example, when the candidate app icon 342 corresponding to the video app, displayed in the app selection pop-up 340, is tapped, the control unit 190 terminates the SNS app that is running and launches the video app corresponding to the candidate app icon 342 that was tapped.

Additionally, as illustrated on the right side of FIG. 12, the control unit 190 hides the SNS app screen 260b and displays the video app screen 260c superimposed on the first application screen 201. Furthermore, the control unit 190 displays the icon corresponding to the video app as the running app icon 341, and displays the icon corresponding to the terminated SNS app as a candidate app icon 342.

Note that the app selection pop-up 340 remains displayed when the video app screen 260c is displayed. Then, when the first application screen 201 or the second application screen 260 is tapped by the user, the control unit 190 hides the app selection pop-up 340 and focuses on the application corresponding to the tapped application screen.

### [2.3 Launching Multiple Second Applications]

In a multi mode, where multiple second applications are launched, the control unit 190 can launch multiple second applications using the extension application. Note that which of the single mode and the multi mode is selected may be set in advance or the like, or may be switched in response to a predetermined user operation. It is also possible to provide only one of the single mode or the multi mode.

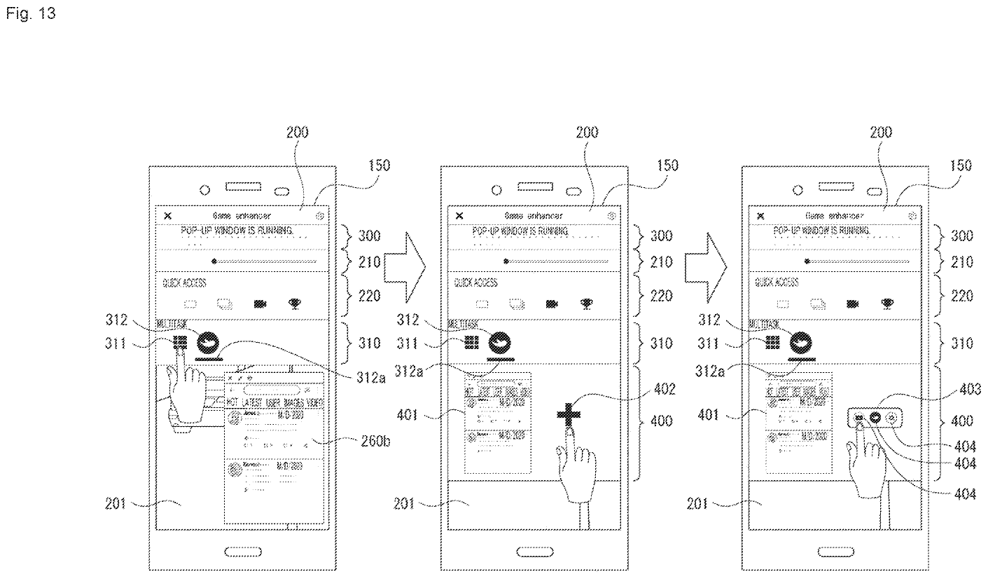

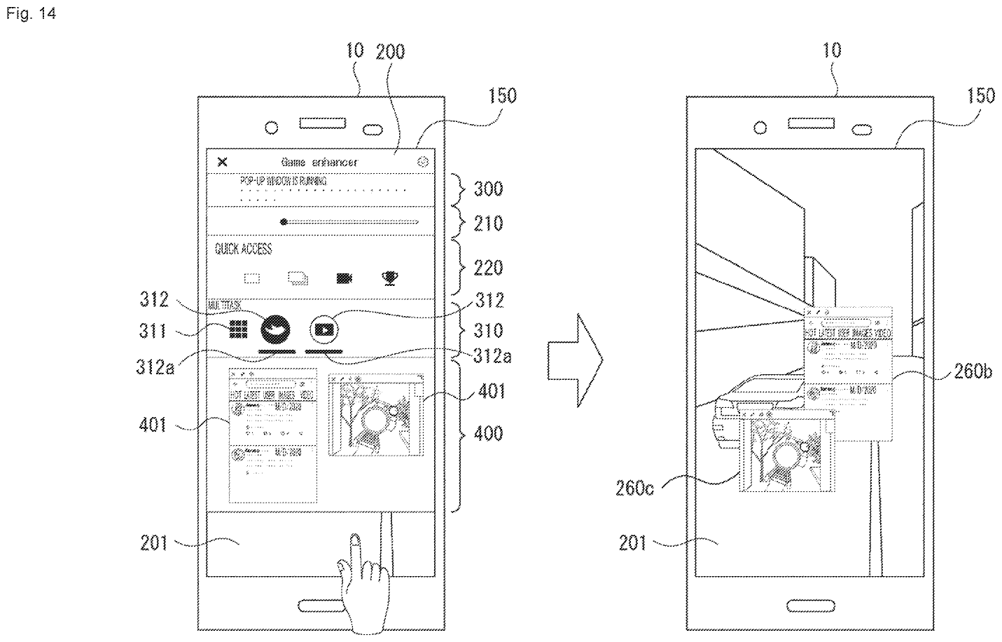

FIGS. 13 and 14 are diagrams illustrating examples of operations involved in launching multiple second applications.

If a user operation for displaying the extended function menu 200 is made while the second application screen 260 (the SNS app screen 260b, here) is displayed superimposed on the first application screen 201, the control unit 190 displays the extended function menu 200 in the display unit 150, as illustrated on the left side of FIG. 13.

Similar to the left side of FIG. 8, the multitask running display area 300 and a multitask selection area 310 are provided in the extended function menu 200 displayed here, in addition to the brightness adjustment bar display area 210 and the quick access icon display area 220.

Then, when the multitask icon 311 of the multitask running display area 300 is tapped, the control unit 190 displays a launched app selection area 400 below the multitask selection area 310 in the extended function menu 200, as illustrated in the center of FIG. 13. Accordingly, the multitask icon 311 also functions as an operator for displaying the launched app selection area 400.

A thumbnail image 401 of the second application currently running, and an add app icon 402, are displayed in the launched app selection area 400.

The thumbnail image 401 is an image captured of the second application screen 260 immediately before the extended function menu 200 is displayed. Displaying the thumbnail image 401 of the second application currently running in this manner makes it possible for the user to recognize a second application that is minimized, for example.

The add app icon 402 is an icon for adding a second application to be launched. When the add app icon 402 is tapped, the control unit 190 displays an app selection pop-up 403 instead of the add app icon 402, as illustrated on the right side of FIG. 13.

Candidate app icons 404 are arranged and displayed in the app selection pop-up 403. The candidate app icons 404 are icons corresponding to second applications which are not running, and three of these icons are displayed, for example. Three of the candidate app icons 404 may be displayed, for example, in alphabetical order for applications installed in the information processing device 10. The control unit 190 may also count the number of times a second application has been launched for each first application and arrange the candidate app icons 404 in order from the application which has been launched the greatest number of times.

For example, when the candidate app icon 404 corresponding to the video app, displayed in the app selection pop-up 403, is tapped, the control unit 190 launches the video app corresponding to the candidate app icon 404 that was tapped.

Additionally, the control unit 190 displays the video app screen 260c along with the SNS app screen 260b superimposed on the first application screen 201.

Furthermore, the control unit 190 displays the thumbnail image 401 of the video app screen 260c instead of the app selection pop-up 403, as illustrated on the left side of FIG. 14. Note that the add app icon 402 or the app selection pop-up 403 may be displayed in the launched app selection area 400.

The control unit 190 also displays the running app icon 312 corresponding to the video app in the multitask selection area 310. The control unit 190 also displays the icon bar 312a below the running app icon 312 corresponding to the video app.

Note that the extended function menu 200 remains displayed when the video app screen 260c is displayed. Then, when the first application screen 201 or the second application screen 260 is tapped by the user, the control unit 190 hides the extended function menu 200 and focuses on the application corresponding to the tapped application screen, as illustrated on the right side of FIG. 14.

Additionally, when multiple second applications are running, a priority order is set for the multiple second applications that are running, and the audio of the second application highest in the priority order is output from the audio output unit 170, the refresh rate of the second application screen 260 highest in the priority order is set to be higher, and so on. In other words, the second application having the highest priority is executed preferentially.

The running app icons 312 are then displayed in the multitask selection area 310 in order of priority. Specifically, the priority of the second application corresponding to the running app icon 312 displayed furthest on the left is set to the highest priority, with the priority decreasing with progress to the right.

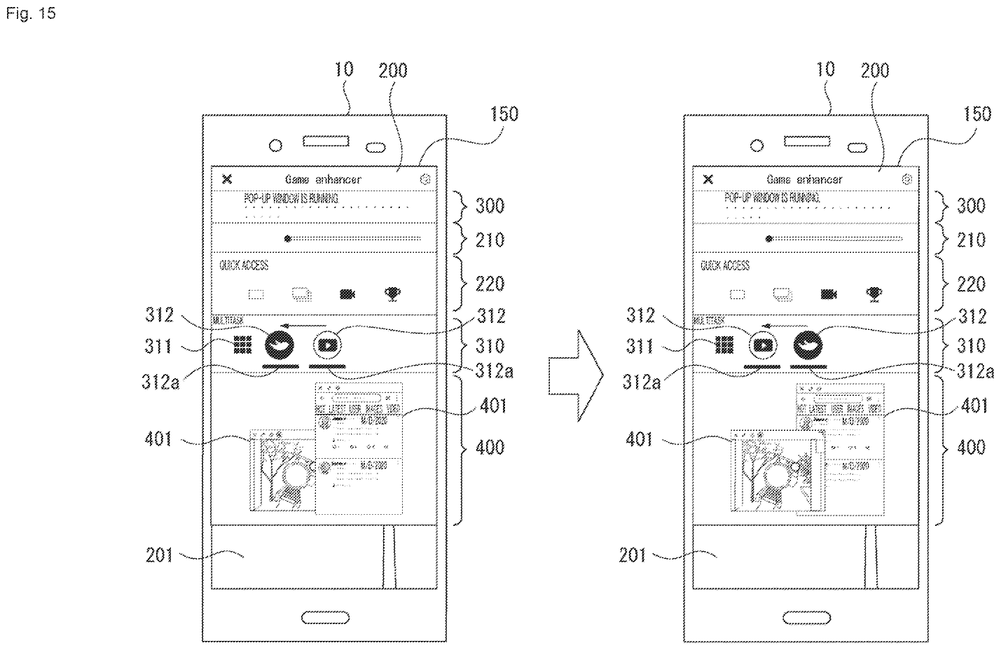

FIG. 15 is a diagram illustrating an example of an operation pertaining to the priority of the second applications.

Assume that, for example, the SNS app and the video app are running, and the SNS app is set to have a higher priority than the video app. In this case, the running app icon 312 corresponding to the SNS app is displayed furthest on the left in the multitask selection area 310, and the running app icon 312 corresponding to the video app is displayed to the right thereof.

Accordingly, audio from the SNS app is output from the audio output unit 170, whereas audio from the video app is not output from the audio output unit 170. Additionally, the SNS app screen 260b is displayed in a higher layer than the video app screen 260c. Furthermore, the refresh rate of the SNS app screen 260b is set to be higher than that of the video app screen 260c.

Then, when the user wishes to listen to the audio of the video app, they change the priority of the video app.

Specifically, as illustrated by the arrow on the left side of FIG. 15, the running app icon 312 corresponding to the video app is dragged to the left side of the running app icon 312 corresponding to the SNS app. By doing so, the running app icon 312 corresponding to the video app is displayed on the left side, and the running app icon 312 corresponding to the SNS app is displayed on the right side, as illustrated on the right side of FIG. 15. At this time, the control unit 190 sets the priority of the video app to be higher than that of the SNS app, and focuses on the video app.

Through this, the control unit 190 causes the audio of the video app to be output from the audio output unit 170, and causes the video app screen 260c to be displayed in a higher layer than the SNS app screen 260b. The control unit 190 also sets the refresh rate of the video app screen 260c to be higher than that of the SNS app screen 260b.

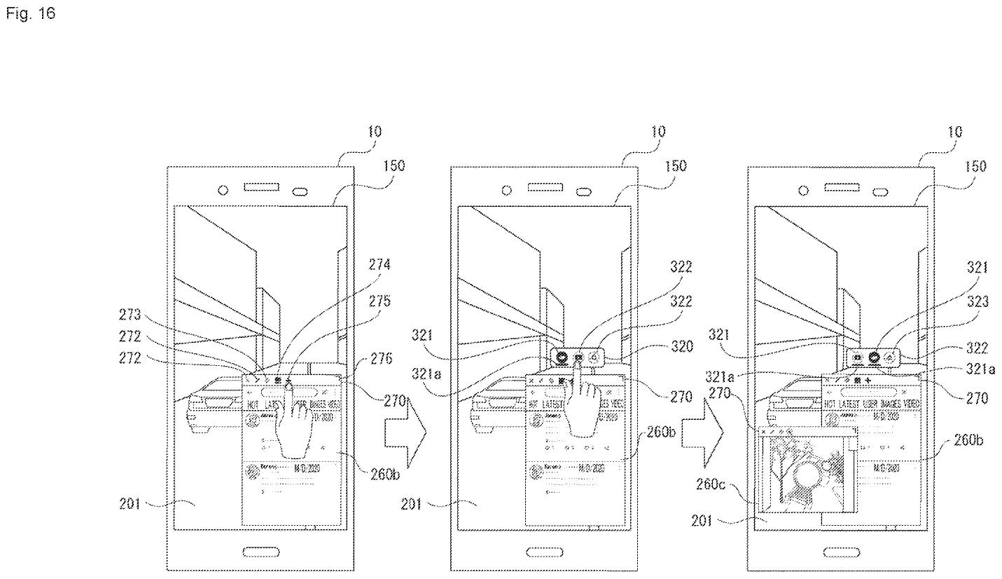

Another method for launching multiple second applications will be described next. FIG. 16 is a diagram illustrating an example of other operations involved in launching multiple second applications.

When the add app icon 275 in the multitask operation area 270 is tapped as illustrated on the left side of FIG. 16, the control unit 190 displays the app selection pop-up 320 above the multitask operation area 270, as illustrated in the center of FIG. 16.

For example, when the candidate app icon 322 corresponding to the video app, displayed in the app selection pop-up 320, is tapped as illustrated in the center of FIG. 16, the control unit 190 launches the video app corresponding to the candidate app icon 322 that was tapped while leaving the SNS app running.

Additionally, as illustrated on the right side of FIG. 16, the control unit 190 displays the video app screen 260c superimposed on the first application screen 201 along with the SNS app screen 260b. Furthermore, the control unit 190 displays the icons corresponding to the SNS app and the video app as the running app icons 321. Note that in this example, the control unit 190 sets the priority of the second application launched after (the video app) to be higher than the priority of the second application that was already running (the SNS app).

Note that if the app selection pop-up 320 continues to be displayed when the video app screen 260c is displayed, and the first application screen 201 or the second application screen 260 is tapped by the user, the control unit 190 hides the app selection pop-up 320 and focuses on the application corresponding to the tapped application screen.

Yet another method for launching multiple second applications will be described next.

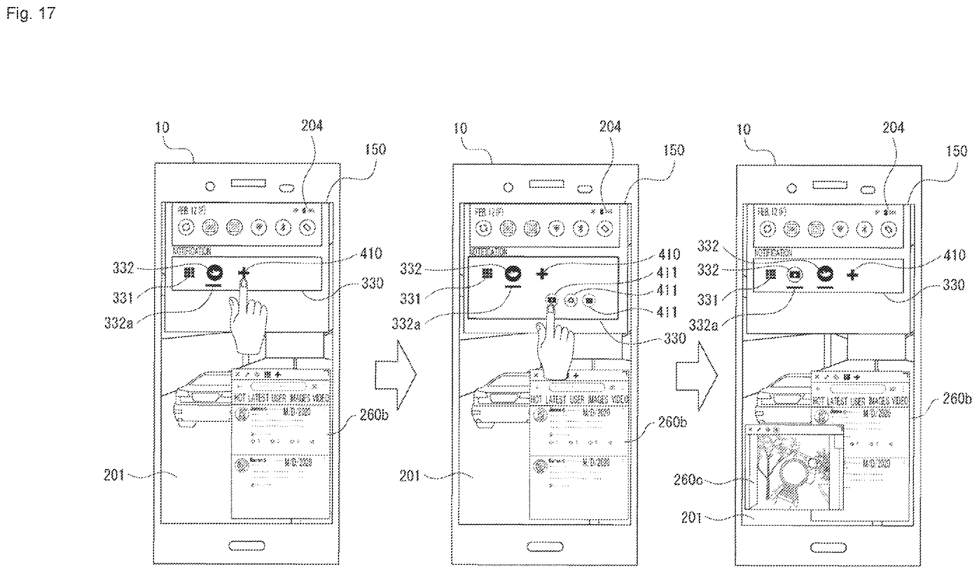

FIG. 17 is a diagram illustrating an example of other operations involved in launching multiple second applications.

If a user operation for displaying the OS menu 204 is made while the second application screen 260 (the SNS app screen 260b, here) is displayed superimposed on the first application screen 201, the control unit 190 displays the OS menu 204 in the display unit 150.

At this time, in addition to the multitask icon 331 and the running app icon 332, an add app icon 410 is displayed in the extension app notification box 330, as illustrated on the left side of FIG. 17.

The add app icon 410 is an icon for adding a second application to be launched. When the add app icon 410 is tapped, the control unit 190 arranges and displays candidate app icons 411 below the add app icon 410, as illustrated in the center of FIG. 17.

The candidate app icons 411 are icons corresponding to second applications which are not running, and three of these icons are displayed, for example. Three of the candidate app icons 411 may be displayed, for example, in alphabetical order for applications installed in the information processing device 10. The control unit 190 may also count the number of times a second application has been launched for each first application and arrange the candidate app icons 411 in order from the application which has been launched the greatest number of times.

For example, when the candidate app icon 411 corresponding to the video app, displayed in the extension app notification box 330, is tapped, the control unit 190 launches the video app corresponding to the candidate app icon 411 that was tapped.

Additionally, the control unit 190 displays the video app screen 260c along with the SNS app screen 260b superimposed on the first application screen 201. The control unit 190 further displays the icon bar 332a below the running app icon 332 corresponding to the video app, as illustrated on the right side of FIG. 17. Note that in this example, the control unit 190 sets the priority of the second application launched after (the video app) to be higher than the priority of the second application that was already running (the SNS app).

Note that if the OS menu 204 continues to be displayed when the video app screen 260c is displayed, and the first application screen 201 or the second application screen 260 is tapped by the user, the control unit 190 hides the OS menu 204 and focuses on the application corresponding to the tapped application screen.

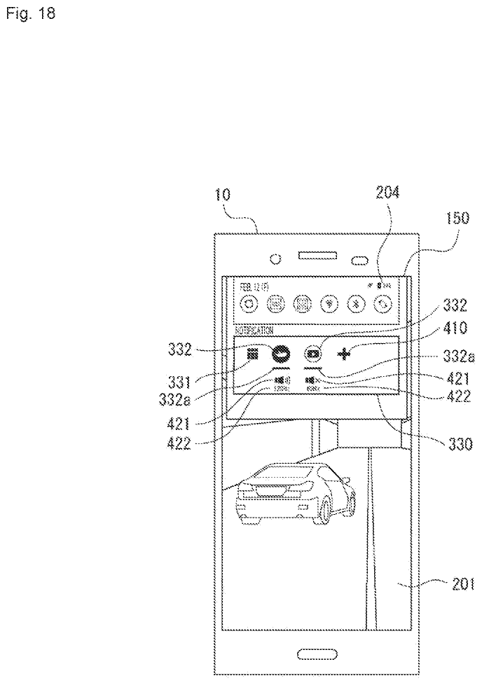

FIG. 18 is a diagram illustrating an example of a display pertaining to the priority of the second applications. Assume that multiple second applications (the SNS app and the video app) are running, and the SNS app is set to have a higher priority than the video app. In this case, the running app icons 332 corresponding to the second applications that are running are arranged and displayed in the extension app notification box 330 of the OS menu 204, as illustrated in FIG. 18.

The icon bar 332a is displayed below the running app icons 332, as are and audio on/off mark 421 and a refresh rate 422.

The audio on/off mark 421 is a mark indicating whether audio is being output based on the priority. For example, below the running app icon 332 corresponding to the SNS app (the left side), the audio on/off mark 421 is displayed as a mark indicating audio is being output. On the other hand, below the running app icon 332 corresponding to the video app, the audio on/off mark 421 is displayed as a mark indicating audio is not being output.

The refresh rate 422 indicates the refresh rate of the second application screen 260 based on the priority. For example, below the running app icon 332 corresponding to the SNS app (the left side), the refresh rate 422 is displayed as an indication that the screen is refreshed at 120 Hz. On the other hand, below the running app icon 332 corresponding to the video app, the refresh rate 422 is displayed as an indication that the screen is refreshed at 60 Hz.

Then, when the running app icon 332 corresponding to the video app is tapped, the control unit 190 sets the priority of the video app corresponding to the tapped running app icon 332 to be higher than that of the SNS app. Then, for example, the audio on/off mark 421 is displayed as a mark indicating that audio is being output below the running app icon 332 corresponding to the video app, and the audio on/off mark 421 is displayed as a mark indicating that audio is not being output below the running app icon 332 corresponding to the SNS app.

By displaying the audio on/off mark 421 and the refresh rate 422 in association with the running app icons 332 in this manner, the user can easily determine the second application having the highest priority.

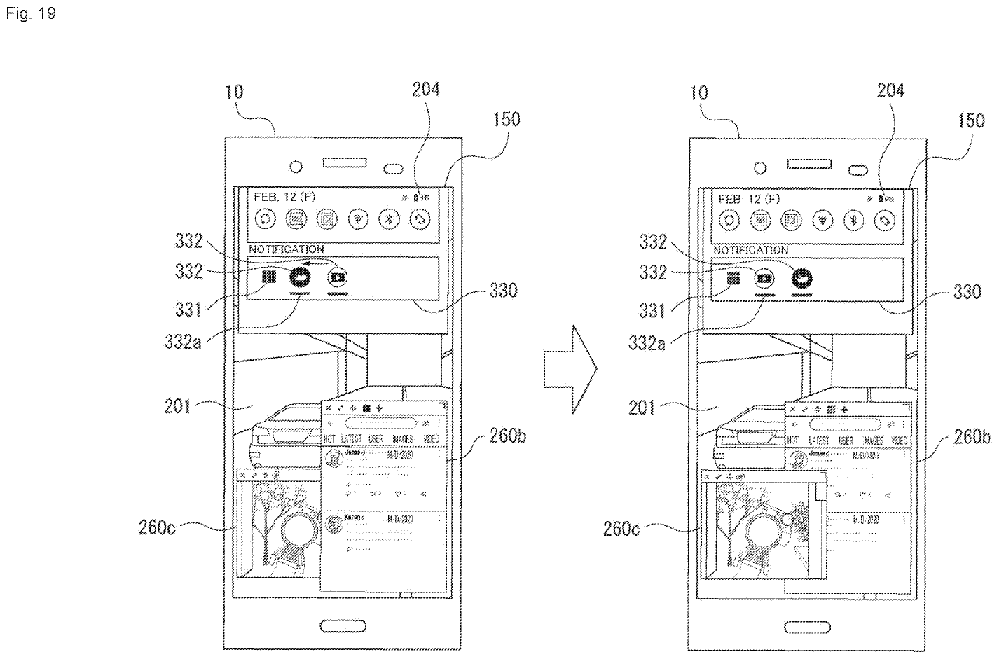

FIG. 19 is a diagram illustrating another example of a display pertaining to the priority of the second applications. Assume here, too, that multiple second applications (the SNS app and the video app) are running, and the SNS app is set to have a higher priority than the video app.

The running app icons 332 corresponding to the second applications that are currently running (the SNS app and the video app) are displayed in the extension app notification box 330. In this example, the second application corresponding to the running app icon 332 displayed on the left is set to the highest priority.

Then, as illustrated by the arrow on the left side of FIG. 19, the running app icon 332 corresponding to the video app is dragged to the left side of the running app icon 332 corresponding to the SNS app. In response, the control unit 190 sets the video app to have a higher priority than the SNS app. Additionally, the running app icon 332 corresponding to the video app is displayed on the left side, and the running app icon 332 corresponding to the SNS app is displayed on the right side, as illustrated on the right side of FIG. 19.

Through this, the control unit 190 causes the audio of the video app to be output from the audio output unit 170, and causes the video app screen 260c to be displayed in a higher layer than the SNS app screen 260b.

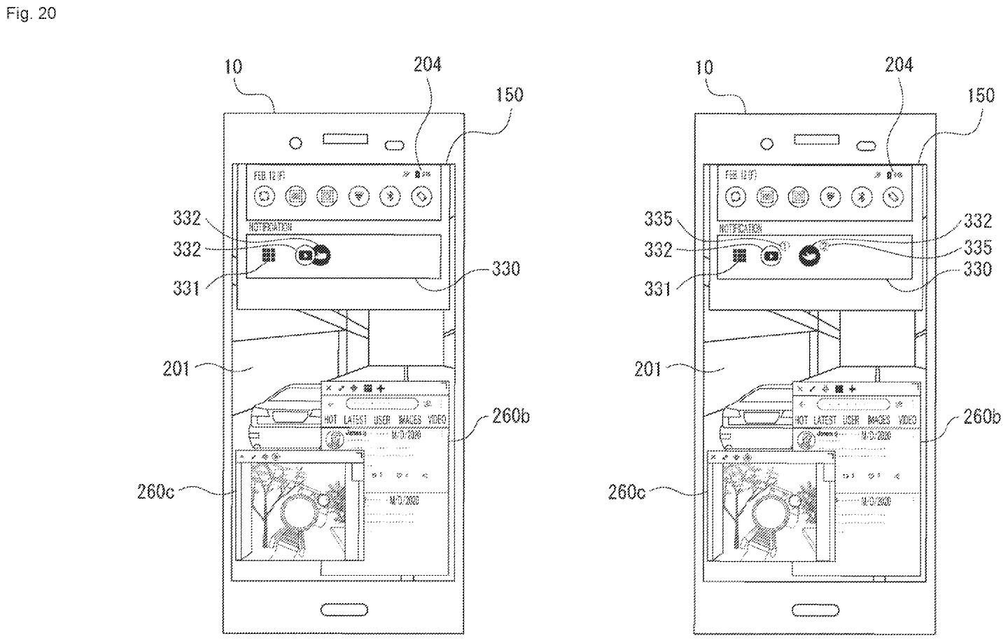

FIG. 20 is a diagram illustrating another example of a display pertaining to the priority of the second applications. Note that in this example, multiple second applications (the SNS app and the video app) are running, and the video app is set to have a higher priority than the SNS app.

The running app icons 332 corresponding to the second applications that are currently running (the SNS app and the video app) are displayed in the extension app notification box 330 of the OS menu 204. At this time, the running app icon 332 displayed on the left side is displayed superimposed on the running app icon 332 displayed on the right side, as illustrated on the left side of FIG. 20. This makes it possible for the user to easily determine the second application for which the highest priority is set.

Additionally, a numeric display 335, starting from the number 1, may be displayed in the vicinity of the running app icons 332 displayed in the extension app notification box 330, as illustrated on the right side of FIG. 20. This makes it possible for the user to easily determine the second application for which the highest priority is set.

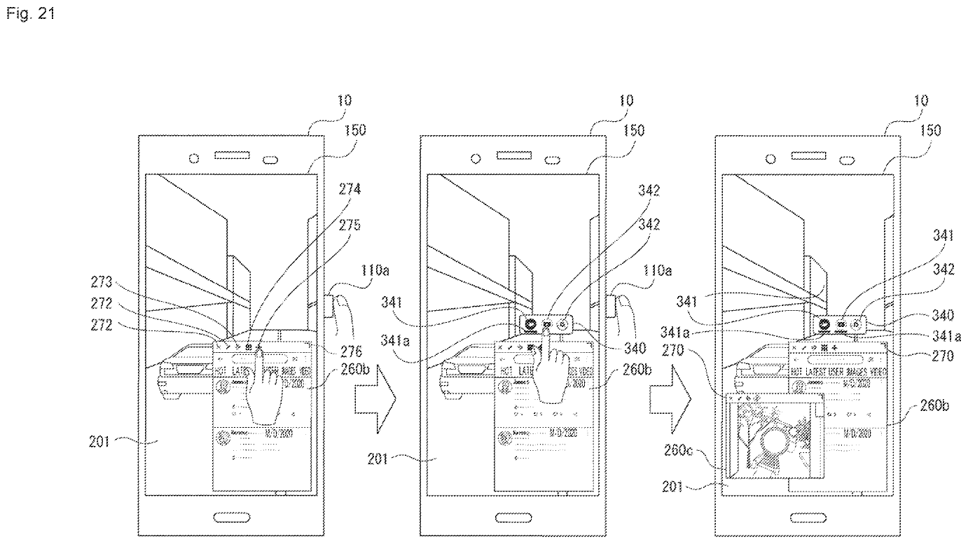

Another method for launching multiple second applications will be described next. FIG. 21 is a diagram illustrating an example of other operations involved in launching multiple second applications.

As illustrated on the left side of FIG. 21, when an operation for pressing an operation button 110a, which serves as a predetermined operation unit 110, is performed by the user while the second application (here, the SNS app) is running, the control unit 190 displays the app selection pop-up 340 in (a corresponding position in) the vicinity of the operation button 110a, as illustrated in the center of FIG. 21.

A running app icon 341 and candidate app icons 342 are arranged and displayed in the app selection pop-up 340.

The running app icon 341 is an icon corresponding to the second application currently running. The running app icon 341 is then displayed to the left of the candidate app icons 342 in the app selection pop-up 340. An icon bar 341a, which indicates that the corresponding second application is running, is displayed below the running app icon 341.

The candidate app icons 342 are icons corresponding to second applications which are not running, and two of these icons are displayed, for example. Two of the candidate app icons 342 may be displayed, for example, in alphabetical order for applications installed in the information processing device 10. The control unit 190 may also count the number of times a second application has been launched for each first application and arrange the candidate app icons 342 in order from the application which has been launched the greatest number of times.

For example, when the candidate app icon 342 corresponding to the video app, displayed in the app selection pop-up 340, is tapped, the control unit 190 launches the video app corresponding to the candidate app icon 342 that was tapped.

Additionally, as illustrated on the right side of FIG. 21, the control unit 190 displays the video app screen 260c superimposed on the first application screen 201 along with the SNS app screen 260b. Furthermore, the control unit 190 displays the icons corresponding to the SNS app and the video app as the running app icons 321.

Note that the app selection pop-up 340 remains displayed when the video app screen 260c is displayed. Then, when the first application screen 201 or the second application screen 260 is tapped by the user, the control unit 190 hides the app selection pop-up 340 and focuses on the application corresponding to the tapped application screen.

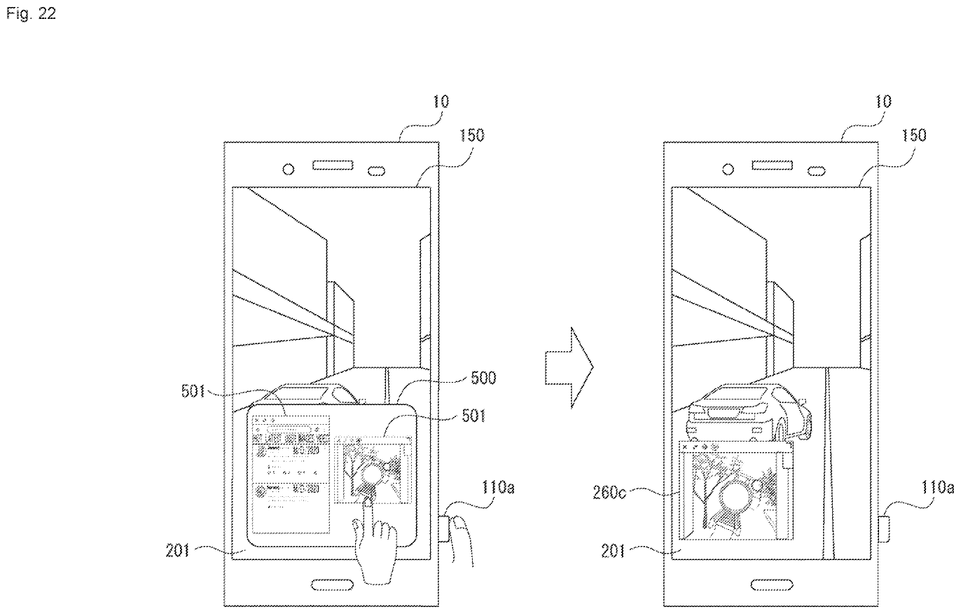

Another method for launching multiple second applications will be described next. FIG. 22 is a diagram illustrating an example of other operations involved in launching multiple second applications.

When an operation for pressing an operation button 110a, which serves as a predetermined operation unit 110, is performed by the user while the second applications (here, the SNS app and the video app) are running, the control unit 190 displays an app selection pop-up 500 in the vicinity of the operation button 110a, as illustrated on the left side of FIG. 22.

Thumbnail images 501 of the second applications currently running are displayed in the app selection pop-up 500.

The thumbnail image 501 is an image captured of the second application screen 260 immediately before the extended function menu 200 is displayed. Displaying the thumbnail image 501 of the second application currently running in this manner makes it possible for the user to recognize a second application that is minimized, for example.

Then, for example, using a similar method as that illustrated in FIG. 13, the control unit 190 launches multiple second applications, and displays the second application screen 260 corresponding to each launched second application superimposed on the first application screen 201, as illustrated on the right side of FIG. 22. When the thumbnail image 501 corresponding to the video app is tapped, the control unit 190 sets the priority of the tapped thumbnail image 501 to be higher than that of the SNS app.

### 3. EXAMPLE OF HARDWARE CONFIGURATION

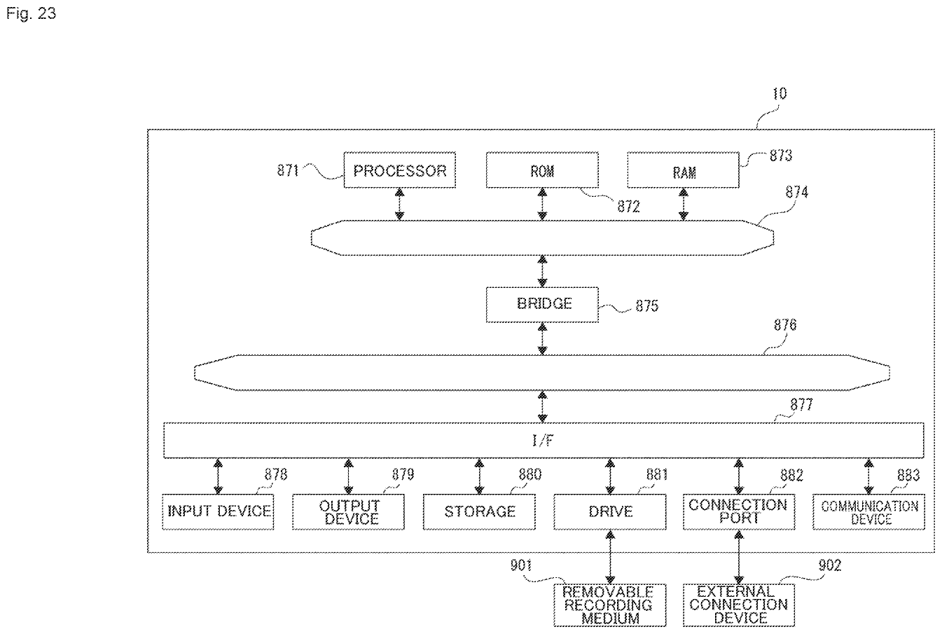

An example of the hardware configuration of the information processing device 10 according to an embodiment of the present disclosure will be described next. FIG. 23 is a block diagram illustrating an example of the hardware configuration of the information processing device 10.

As illustrated in FIG. 23, the information processing device 10 includes a processor 871, a ROM 872, a RAM 873, a host bus 874, a bridge 875, an external bus 876, an interface 877, an input device 878, an output device 879, storage 880, a drive 881, a connection port 882, and a communication device 883, for example. Note that the hardware configuration illustrated here is merely an example, and some of the constituent elements may be omitted. Additionally, constituent elements aside from those illustrated here may be further included.

### (Processor 871)

The processor 871 functions as, for example, an arithmetic processing device or a control device, and controls all or some of the operations of the constituent elements based on various types of programs, data, and the like recorded in the ROM 872, the RAM 873, the storage 880, or a removable recording medium 901.

### (ROM 872, RAM 873)

The ROM 872 is a means for storing programs loaded by the processor 871, data used for computations, and the like. Programs loaded by the processor 871, various types of parameters and the like that change as appropriate when executing the programs, and the like, for example, are stored in the RAM 873 temporarily or permanently.

### (Host Bus 874, Bridge 875, External Bus 876, Interface 877)

The processor 871, the ROM 872, and the RAM 873 are connected to each other by, for example, the host bus 874, which is capable of high-speed data transmission. Meanwhile, the host bus 874 is connected to the external bus 876, which has a relatively low data transmission speed, by the bridge 875, for example. The external bus 876 is connected to various constituent elements by the interface 877.

### (Input Device 878)

A mouse, a keyboard, a touch panel, buttons, switches, levers, and the like are used for the input device 878, for example. Further, as the input device 878, a remote controller capable of transmitting a control signal using infrared rays or other radio waves may be used. The input device 878 includes an audio input device such as a microphone.

### (Output Device 879)

The output device 879 is, for example, a device capable of notifying users of obtained information visually or audibly, including a display device such as a cathode ray tube (CRT) display, an LCD, or an organic EL display, an audio output device such as a speaker or a headphone, a printer, a mobile phone, a facsimile device, or the like. The output device 879 according to the present disclosure includes various types of vibration devices capable of outputting tactile stimuli.

### (Storage 880)

The storage 880 is a device for storing various types of data. As the storage 880, for example, a magnetic storage device such as a hard disk drive (HDD), a semiconductor storage device, an optical storage device, a magneto-optical storage device, or the like is used.

### (Drive 881)

The drive 881 is a device that reads out information recorded on the removable recording medium 901, which is a magnetic disk, an optical disk, a magneto-optical disk, a semiconductor memory, or the like, or writes information to the removable recording medium 901, for example.

### (Removable Recording Medium 901)

The removable recording medium 901 is, for example, a DVD medium, a Blu-ray (registered trademark) medium, an HD DVD medium, various types of semiconductor storage media, or the like. Naturally, the removable recording medium 901 may be, for example, an IC card equipped with a non-contact type IC chip, an electronic device, or the like.

### (Connection Port 882)

The connection port 882 is a port for connecting an external connection device 902, such as a Universal Serial Bus (USB) port, an IEEE 1394 port, a Small Computer System Interface (SCSI), an RS-232C port, an optical audio terminal, or the like, for example.

### (External Connection Device 902)

The external connection device 902 is, for example, a printer, a portable music player, a digital camera, a digital video camera, an IC recorder, or the like.

### (Communication Device 883)

The communication device 883 is a communication device for connecting to a network, and is, for example, a communication card for wired or wireless LAN, Bluetooth (registered trademark), or Wireless USB (WUSB), a router for optical communication, a router for Asymmetric Digital Subscriber Line (ADSL), or a modem for various types of communication.

The configuration of the information processing device 10 described above can be thought of as the configuration of a terminal device in which the first application is run (a smartphone, a PC, or the like) for example. The configuration can also be thought of as that of an information processing device serving as the above-described server device.

### 4. CONCLUSION AND VARIATION

The embodiment described above provides the following effects.

The embodiment includes a control unit configured to launch a second application while a first application is running, the second application being launched through an extension application that provides an extended function to the first application, and display a screen of the second application superimposed on a screen of the first application.

This makes it possible to easily execute the second application at the same time as the first application through the extension application.

Accordingly, the information processing device 10 can improve the user experience.

In the embodiment, the control unit 190 is configured to display icons of a plurality of applications (the app icons 251) in the extended function menu 200 of the extension application, and when a user selects one of the icons displayed in the extended function menu, launch the second application corresponding to the selected icon and keep the extended function menu displayed (FIG. 6).

Through this, even if the user accidentally taps an app icon 251, the user can immediately tap another app icon 251 and launch the second application corresponding to that app icon 251. In other words, the information processing device 10 makes it possible to switch the second application with ease.

In the embodiment, the control unit 190 is configured to hide the extended function menu 200 when the first application screen 201 or the second application screen 260 is operated by the user, and focus on an application corresponding to the operated screen (FIG. 7).

This makes it possible for the user to immediately operate the application corresponding to the screen they touched.

In the embodiment, the control unit 190 is configured to, when one of the icons displayed in the extended function menu 200 (the app icons 251) is selected by the user while the second application is running, terminate the second application that is running and launch the second application corresponding to the selected icon; and display a screen of the second application corresponding to the selected icon superimposed on the screen of the first application (FIG. 7).

This makes it possible to easily change the second application screen displayed superimposed on the first application screen.

In the embodiment, the control unit 190 is configured to hide the screen of the second application (the second application screen 260) that has been terminated. This makes it possible to display the screen of the newly-selected second application in an easily viewable manner.

In the embodiment, the control unit 190 is configured to provide a display area (the multitask running display area 300) for displaying an indication that the second application is running in the extended function menu 200 when the second application is running (FIG. 8).

This makes it possible to confirm that the second application is running in the display area.

In the embodiment, the control unit 190 is configured to terminate the second application when the display area (the multitask running display area 300) is operated (FIG. 8).

This makes it possible to easily terminate the second application. Furthermore, even if multiple second applications are running, those second applications can be terminated all at once.

In the embodiment, the control unit 190 is configured to display a predetermined icon (the running app icon 321 and the candidate app icon 322) in a position corresponding to the screen of the second application, and switch the second application that is launched in response to an operation made on the icon (FIG. 10). This makes it possible to easily switch the second application without displaying the extended function menu 200 in the display unit 150.

In the embodiment, the control unit 190 is configured to launch a plurality of second applications, and display screens of the plurality of second applications that are running superimposed on the screen of the first application (FIG. 14).

Through this, multiple second applications can be launched simultaneously in addition to the first application, and the screens thereof can be viewed by the user. Accordingly, the information processing device 10 can improve the user experience.

In the embodiment, the control unit 190 is configured to arrange and display icons of the second applications that are running (the running app icons 312) in the extended function menu 200.

This makes it possible to confirm the second applications that are running in the extended function menu 200.

In the embodiment, the control unit 190 is configured to change a priority order of the second applications in response to a user operation of the icons (the running app icons 312) (FIG. 15).

This makes it possible, for example, to preferentially output the audio and video of a second application higher in the priority order.

In the embodiment, the control unit 190 is configured to display a predetermined icon (the candidate app icon 342) in a position corresponding to the second application screen 260, and launch a second application selected in accordance with an operation made on the icon (FIG. 21).

Through this, multiple second applications can be launched easily, and the screens of those second applications can be viewed by the user with ease.

In the embodiment, the control unit 190 is configured to display an icon of the second application (the candidate app icon 411) in a notification menu of an operating system (the OS menu 204), and launch the second application corresponding to the icon in accordance with an operation made on the icon (FIG. 17).

Through this, the second application can also be launched through the extension application by an operation made in the notification menu of the operating system, which makes it possible to further improve the user experience.

In the embodiment, the control unit 190 is configured to display the icon of the second application (the running app icon 332) in the notification menu (the OS menu 204) in accordance with a priority order (FIG. 19).

Through this, the priority order of the second applications can be understood through the notification menu of the operating system as well.

In the embodiment, the control unit 190 is configured to display an icon of the second application (the running app icon 341 and the candidate app icon 342) near the operation button 110a when the operation button is operated by a user, and switch the second application that is launched in response to an operation made on the icon (FIG. 12).

This makes it possible to switch the second application corresponding to an operation made on a physical operation button.

An information processing method according to the embodiment includes launching a second application while a first application is running, the second application being launched through an extension application that provides an extended function to the first application, and displaying a screen of the second application superimposed on a screen of the first application.

A program according to the embodiment causes an information processing device to execute processing of launching a second application while a first application is running, the second application being launched through an extension application that provides an extended function to the first application, and displaying a screen of the second application superimposed on a screen of the first application.

This program is a program executed by the processor 871 of the information processing device 10.

The program that realizes the information processing device 10 can be recorded in advance in an HDD serving as a recording medium embedded in a device such as a computer device or a ROM or the like in a microcomputer that includes a CPU. Alternatively, the program can be stored (recorded) temporarily or perpetually on a removable recording medium such as a flexible disc, a compact disc read-only memory (CD-ROM), a magneto optical (MO) disc, a digital versatile disc (DVD), a Blu-ray Disc (registered trademark), a magnetic disk, a semiconductor memory, or a memory card. The removable recording medium can be provided as so-called package software.

The program can be installed from the removable recording medium on a personal computer or the like and can also be downloaded from a download site via a network such as a local area network (LAN) or the Internet.

Such a program is suited to providing the information processing device 10 of the embodiment over a broad scope. For example, by downloading the program to a mobile terminal device such as a smartphone or a tablet, a mobile phone, a personal computer, a game console, a video device, a Personal Digital Assistant (PDA), or the like, it is possible to cause the smartphone or the like to function as the information processing device 10 according to the present disclosure.

Note that the effects described in the present specification are merely exemplary and not intended to be limiting, and other effects may be provided as well.

Additionally, the above-described methods for switching the second application and launching multiple second applications are merely examples, and it is sufficient for the information processing device 10 to be capable of executing at least one of the methods.

Additionally, when multiple second application screens 260 are displayed in the display unit 150, the positions, sizes, transparencies, and hierarchical order may be changed as appropriate. For example, if the position of the user's line of sight can be detected, the second application screen 260 corresponding to the position of the user's line of sight may be displayed at a larger size.

Additionally, the audio output corresponding to the plurality of second application screens 260 may be changed as appropriate. For example, if the position of the user's line of sight can be detected, the audio of the second application screen 260 corresponding to the position of the user's line of sight may be made louder, and the audio of the second application screen 260 not in the position of the user's line of sight may be made quieter.

Additionally, when minimizing the second application screen 260, an icon bar indicating that the second application screen is minimized may be displayed below the corresponding running app icons 312 and 332 in the extended function menu 200, the OS menu 204, or the like.

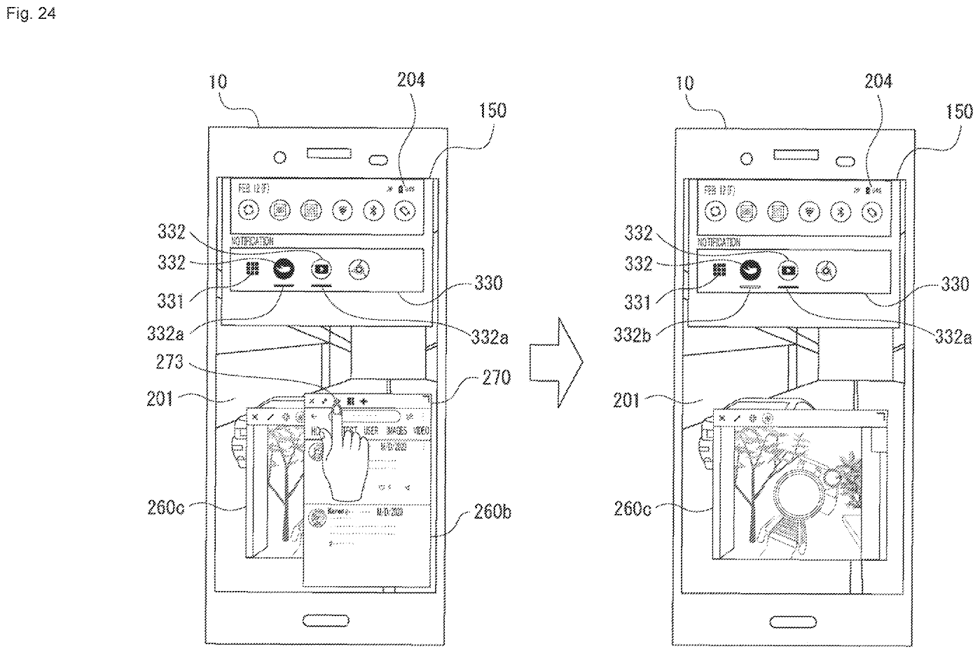

For example, assume that the SNS app and the video app are running, and the SNS app screen 260b and the video app screen 260c are displayed, as illustrated on the left side of FIG. 24. In such a case, when the minimize icon 273 of the multitask operation area 270 corresponding to the SNS app screen 260b is tapped, the control unit 190 minimizes (hides) the SNS app screen 260b as illustrated on the right side of FIG. 24. Additionally, when the OS menu 204 is displayed, the control unit 190 may display an icon bar 332b, which indicates that the corresponding SNS app (second application) is minimized, below the running app icon 332 corresponding to the SNS app in the OS menu 204.

Additionally, when displaying multiple second application screens 260 in the display unit 150, it may be made possible to set a second application screen 260 for which a screenshot is to be captured and a second application screen 260 for which a screenshot is not to be captured.

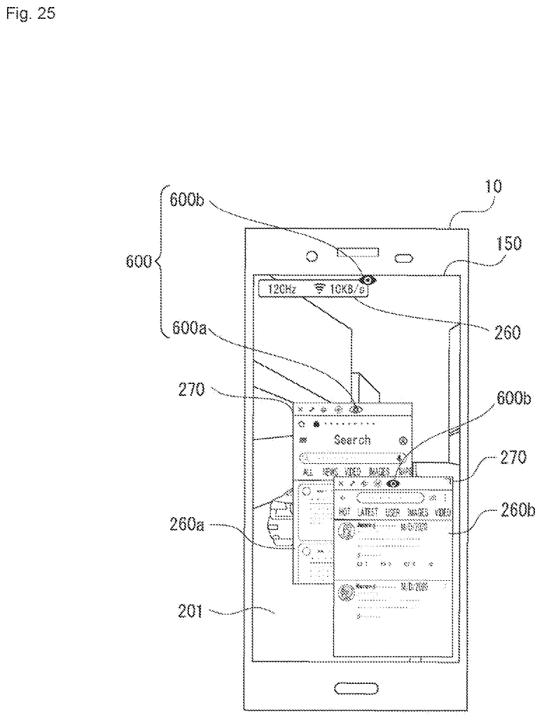

For example, the control unit 190 displays a display icon 600 indicating whether a screenshot is to be captured in the vicinity of the second application screen 260 or in the multitask operation area 270, as illustrated in FIG. 25. Note that the display icon 600 is displayed as either a display active icon 600a indicating that a screenshot is to be captured or a display hidden icon 600b indicating that a screenshot is not to be captured, and these are associated with the corresponding second applications (second application screens 260). Then, when the display icon 600 is tapped, the control unit 190 switches the display active icon 600a or the display hidden icon 600b that was displayed before the tap to a different icon for display.

When capturing a screenshot, the control unit 190 captures the second application screen 260 associated with the display active icon 600a together, and does not capture the second application screen 260 associated with the display hidden icon 600b.

The control unit 190 may also distinguish between a second application important to the user and other second applications, and display the second application screen 260 corresponding to the important second application at a larger size, increase the volume of the audio, and the like.

The present technique can also be configured as follows.

(1)

An information processing device including:
a control unit configured to:
launch a second application while a first application is running, the second application being launched through an extension application that provides an extended function to the first application; and
display a screen of the second application superimposed on a screen of the first application.

(2)

The information processing device according to (1),
wherein the control unit is configured to:
display icons of a plurality of second applications in an extended function menu of the extension application; and
when a user selects one of the icons displayed in the extended function menu, launch the second application corresponding to the selected icon and keep the extended function menu displayed.

(3)

The information processing device according to (2),
wherein the control unit is configured to hide the extended function menu when the screen of the first application or the screen of the second application is operated by the user, and focus on an application corresponding to the operated screen.

(4)

The information processing device according to (2) or (3),
wherein the control unit is configured to:
when one of the icons displayed in the extended function menu is selected by a user while the second application is running, terminate the second application that is running and launch the second application corresponding to the selected icon; and display a screen of the second application corresponding to the selected icon superimposed on the screen of the first application.

(5)

The information processing device according to (4),
wherein the control unit is configured to hide the screen of the second application that has been terminated.

(6)

The information processing device according to any one of (2) to (5),
wherein the control unit is configured to provide a display area for displaying an indication that the second application is running in the extended function menu when the second application is running.

(7)

The information processing device according to (6),
wherein the control unit is configured to terminate the second application when the display area is operated.

(8)

The information processing device according to any one of (1) to (7),
wherein the control unit is configured to:
display a predetermined icon in a position corresponding to the screen of the second application; and
switch the second application that is launched, in accordance with an operation made on the icon.
(6)

The information processing device according to any one of (1) to (8),
wherein the control unit is configured to:
launch a plurality of second applications; and
display screens of the plurality of second applications that are running, superimposed on the screen of the first application.

(10)

The information processing device according to any one of (2) to (7),
wherein the control unit is configured to arrange and display icons of the second applications that are running in the extended function menu.

(11)

The information processing device according to (10),
wherein the control unit is configured to change a priority order of the second applications in response to a user operation of the icons.

(12)

The information processing device according to any one of (1) to (11), wherein the control unit is configured to:
display a predetermined icon in a position corresponding to the screen of the second application; and
launch a second application selected in accordance with an operation made on the icon.

(13)

The information processing device according to any one of (1) to (12), wherein the control unit is configured to:
display an icon of the second application in a notification menu of an operating system; and
launch the second application corresponding to the icon in accordance with an operation made on the icon.

(14)

The information processing device according to (13),
wherein the control unit is configured to display the icon of the second application in the notification menu in accordance with a priority order.

(15)

The information processing device according to (10), wherein the control unit is configured to:
display an icon of the second application near an operation button when the operation button is operated by a user; and
switch the second application that is launched, in accordance with an operation made on the icon.

(16)

An information processing method including:
launching a second application while a first application is running, the second application being launched through an extension application that provides an extended function to the first application; and displaying a screen of the second application superimposed on a screen of the first application.

(17)

A program that causes an information processing device to execute processing of: launching a second application while a first application is running, the second application being launched through an extension application that provides an extended function to the first application; and
displaying a screen of the second application superimposed on a screen of the first application.

### REFERENCE SIGNS LIST

10 Information processing device
110 Operation unit
120 Storage unit
130 Image capturing unit
140 Sensor unit
150 Display unit
160 Audio input unit
170 Audio output unit
180 Screen capturing unit
190 Control unit

1. An information processing device comprising:
a control unit configured to:
launch a second application while a first application is running, the second application being launched through an extension application that provides an extended function to the first application; and
display a screen of the second application superimposed on a screen of the first application.

2. The information processing device according to claim 1,
wherein the control unit is configured to:
display icons of a plurality of second applications in an extended function menu of the extension application; and
when a user selects one of the icons displayed in the extended function menu, launch the second application corresponding to the selected icon and keep the extended function menu displayed.

3. The information processing device according to claim 2,
wherein the control unit is configured to hide the extended function menu when the screen of the first application or the screen of the second application is operated by the user, and focus on an application corresponding to the operated screen.

4. The information processing device according to claim 2,
wherein the control unit is configured to:
when one of the icons displayed in the extended function menu is selected by a user while the second application is running, terminate the second application that is running and launch the second application corresponding to the selected icon; and
display a screen of the second application corresponding to the selected icon superimposed on the screen of the first application.

5. The information processing device according to claim 4,
wherein the control unit is configured to hide the screen of the second application that has been terminated.

6. The information processing device according to claim 2,
wherein the control unit is configured to provide a display area for displaying an indication that the second application is running in the extended function menu when the second application is running.

7. The information processing device according to claim 6,
wherein the control unit is configured to terminate the second application when the display area is operated.

8. The information processing device according to claim 1,
wherein the control unit is configured to:
display a predetermined icon in a position corresponding to the screen of the second application; and
switch the second application that is launched, in accordance with an operation made on the icon.

9. The information processing device according to claim 1,
wherein the control unit is configured to:
launch a plurality of second applications; and
display screens of the plurality of second applications that are running, superimposed on the screen of the first application.

10. The information processing device according to claim 2,
wherein the control unit is configured to arrange and display icons of the second applications that are running in the extended function menu.

11. The information processing device according to claim 10,
wherein the control unit changes a priority order of the second applications in response to a user operation of the icons.

12. The information processing device according to claim 1,
wherein the control unit is configured to:
display a predetermined icon in a position corresponding to the screen of the second application; and
launch a second application selected in accordance with an operation made on the icon.

13. The information processing device according to claim 1,
wherein the control unit is configured to:
display an icon of the second application in a notification menu of an operating system; and
launch the second application corresponding to the icon in accordance with an operation made on the icon.

14. The information processing device according to claim 13,
wherein the control unit is configured to display the icon of the second application in the notification menu in accordance with a priority order.

15. The information processing device according to claim 1,
wherein the control unit is configured to:
display an icon of the second application near an operation button when the operation button is operated by a user; and
switch the second application that is launched, in accordance with an operation made on the icon.

16. An information processing method comprising:
launching a second application while a first application is running, the second application being launched through an extension application that provides an extended function to the first application; and
displaying a screen of the second application superimposed on a screen of the first application.

17. A program that causes an information processing device to execute processing of:
launching a second application while a first application is running, the second application being launched through an extension application that provides an extended function to the first application; and
displaying a screen of the second application superimposed on a screen of the first application.
